(19) United States
(12) Patent Application Publication
(10) Pub. No.: US 2022/0416239 A1
(43) Pub. Date: Dec. 29, 2022

(54) SECONDARY BATTERY, PORTABLE INFORMATION TERMINAL, AND VEHICLE

(71) Applicant: SEMICONDUCTOR ENERGY LABORATORY CO., LTD., ATSUGI-SHI, KANAGAWA-KEN (JP)

(72) Inventors: Kazutaka KURIKI, Ebina, Kanagawa (JP); Yumiko YONEDA, Isehara, Kanagawa (JP); Mayumi MIKAMI, Atsugi, Kanagawa (JP); Hiroshi KADOMA, Sagamihara, Kanagawa (JP); Kunihiko SUZUKI, Isehara, Kanagawa (JP); Shunpei YAMAZAKI, Setagaya, Tokyo (JP)

(21) Appl. No.: 17/780,049

(22) PCT Filed: Nov. 26, 2020
(86) PCT No.: PCT/IB2020/061166

§ 371 Date: May 26, 2022

(30) Foreign Application Priority Data
Dec. 3, 2019 (JP) 2019-219137
Dec. 11, 2019 (JP) 2019-223652
Nov. 6, 2020 (JP) 2020-185764

(51) Int. Cl. H01M 4/525; H01M 10/0525; H01M 4/505; H01M 4/583; H01M 10/0567

(52) U.S. Cl. CPC H01M 4/525; H01M 10/0525; H01M 4/505; H01M 4/583; H01M 10/0567; H01M 2004/028

(57) ABSTRACT

A secondary battery that can withstand at least high temperature is achieved by designing the structure of the secondary battery. The secondary battery uses: a positive electrode active material obtained by a formation method including a first step of forming a first mixture by pulverizing magnesium fluoride, lithium fluoride, a nickel source, and an aluminum source and then mixing the pulverized materials with powder of lithium cobalt oxide, and a second step of forming a second mixture by heating the first mixture at a temperature lower than an upper temperature limit of the lithium cobalt oxide; and an electrolyte solution to which LiBOB is added.

### TECHNICAL FIELD

The present invention relates to an object, a method, or a manufacturing method. Alternatively, the present invention relates to a process, a machine, manufacture, or a composition of matter. In particular, one embodiment of the present invention relates to a semiconductor device, a display device, a light-emitting device, a secondary battery, a power storage device, a storage device, a driving method thereof, or a manufacturing method thereof. In particular, one embodiment of the present invention relates to a secondary battery, a power storage device, and a fabrication method thereof.

Note that in this specification, a secondary battery or a power storage device refers to every element and device having a function of storing power.

### BACKGROUND ART

In recent years, a variety of power storage devices such as lithium-ion secondary batteries, lithium-ion capacitors, air batteries, and all-solid batteries have been actively developed. In particular, demand for lithium-ion secondary batteries with high output and high energy density has rapidly grown with the development of the semiconductor industry, for portable information terminals such as mobile phones, smartphones, tablets, and notebook computers; portable music players; digital cameras; medical equipment; next-generation clean energy vehicles such as hybrid electric vehicles (HEVs), electric vehicles (EVs), and plug-in hybrid electric vehicles (PHEVs); and the like. The lithium-ion secondary batteries are essential as rechargeable energy supply sources for today's information society.

Electric vehicles (EV) are vehicles in which only an electric motor is used for a driving portion, and there are also hybrid electric vehicles having both an internal-combustion engine such as an engine and an electric motor. A plurality of secondary batteries used in vehicles are provided as a battery pack, and a plurality of battery packs are provided on the lower portion of a vehicle.

As described above, lithium-ion secondary batteries have been used for a variety of purposes in various fields. The performance required for lithium-ion secondary batteries includes high energy density, excellent cycle performance, and safety in a variety of operation environments.

Patent Document 1 discloses a secondary battery in which lithium bis(oxalato)borate (LiBOB) is added to an electrolyte solution.

A fluoride such as fluorite (calcium fluoride) has been used as flux in iron manufacture or the like for a very long time, and the physical properties have been studied (Non-Patent Document 1).

### REFERENCES

### Patent Document

### [Patent Document 1]

Japanese Published Patent Application No. 2019-179758

### Non-Patent Document

### [Non-Patent Document 1]

W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36[1]12-17 (1953).

### SUMMARY OF THE INVENTION

### Problems to be Solved by the Invention

The temperature in an electric vehicle easily changes depending on the operation state or environment; thus, safety measures for temperature are required. Among components mounted on an electric vehicle, a secondary battery is a power source of the electric vehicle and fulfills the most important function. Meanwhile, there is a problem in that the temperature range allowable for normal operation is narrow for a variety of usage environments of the electric vehicle.

If the temperature environment is out of the normal range, charge and discharge performance and lifetime of a secondary battery might be greatly affected; thus, the secondary battery is desirably used at a constant temperature environment as much as possible. The temperature of the secondary battery is increased not only by the ambient environment problem but also by a flow of a large amount of current due to charging and discharging.

For an electrolyte solution used in a structure of a secondary battery, an organic solvent is used. However, an organic solvent has volatility and a low flash point; thus, when the organic solvent is used in a lithium-ion secondary battery, an increase in the internal temperature of the lithium-ion secondary battery due to an internal short circuit, overcharging, or the like might cause the lithium-ion secondary battery to explode or catch fire. In addition, part of the electrolyte solution (a lithium salt) produces hydrofluoric acid by a hydrolysis reaction; this hydrofluoric acid corrodes metal, which causes a concern for the reliability of the battery.

In view of this, an object is to achieve a secondary battery that can withstand at least high temperature by designing the structure of the secondary battery.

In addition, since a high-capacity secondary battery is mounted on an electric vehicle, it takes a long time to charge from a low capacity state to a full charged state in some cases. To achieve rapid charging, a secondary battery that can withstand high-voltage charging is required. An object of one embodiment of the present invention is to provide a secondary battery that can be charged at a high charge voltage.

Another object of one embodiment of the present invention is to provide a power storage device with little deterioration at high temperature or a high charge voltage. Another object of one embodiment of the present invention is to provide a novel power storage device, a novel electronic device, or the like.

### Means for Solving the Problems

If the charge voltage applied to a secondary battery can be increased, the secondary battery can be charged at a high voltage for a longer time, resulting in an increase in charge amount per unit time and a reduction in charge time. In the field of electrochemical cells typified by lithium-ion secondary batteries, batteries deteriorate when the voltage becomes a high voltage exceeding 4.5 V.

When the charge voltage applied to a secondary battery is increased, a side reaction might occur, contributing to a significant decrease in battery performance. The side reaction refers to formation of a reactant caused by a chemical reaction of an active material or an electrolyte solution, acceleration of oxidation and decomposition of the electrolyte solution, or the like. The decomposition of the electrolyte solution might cause gas generation and volume expansion.

One embodiment of the present invention is a secondary battery in which a boron-based additive agent is added to an electrolyte solution. As the boron-based additive agent, LiBOB or lithium difluoro(oxalato)borate (LiDFOB) can be used.

One embodiment of the present invention uses a positive electrode active material particle containing fluorine.

A method for forming the positive electrode active material particle containing fluorine includes a first step of placing, in a heating furnace, a container in which a lithium oxide and a fluoride are set and a second step of heating inside of the heating furnace in an oxygen-containing atmosphere. The heating temperature in the second step is higher than or equal to 750° C. and lower than or equal to 950° C. The heating temperature in the second step can be a temperature that causes interactive diffusion of elements contained in the lithium oxide and the fluoride. In the case where the fluoride contains LiF and MgF₂, an eutectic point P of LiF and MgF₂ is around 742° C. (T1) as shown in FIG. 13; thus, the heating temperature in the second step is preferably set higher than or equal to 742° C.

In the above, the heating temperature is preferably higher than or equal to 775° C. and lower than or equal to 925° C., further preferably higher than or equal to 800° C. and lower than or equal to 900° C.

In the above, it is preferable that a step of putting a lid on the container be included before heating or during heating, and that the fluoride be lithium fluoride. When a lid is put during heating to make the concentration of a gas of the fluoride in the container constant or not be reduced to keep the state, fluorine can be contained in a surface portion of the particle. The use of the lid allows simple and inexpensive annealing of a positive electrode active material in a fluoride-containing atmosphere. In this specification and the like, a surface portion of a positive electrode active material refers to a region from a surface to a depth of approximately 10 nm. A plane generated by a split and/or a crack may also be referred to as a surface. A region in a deeper position than the surface portion of the positive electrode active material is referred to as an inner portion. In some cases, the surface portion of the positive electrode active material is also referred to as the vicinity of the surface.

A composite oxide containing lithium, a transition metal (cobalt, nickel, manganese, or the like), and oxygen preferably has a layered rock-salt crystal structure with few defects and distortions. Therefore, the composite oxide preferably includes few impurities. In the case where the composite oxide containing lithium, a transition metal, and oxygen includes a lot of impurities, the crystal structure is highly likely to have a lot of defects or distortions.

To prevent impurities from being contained, the surface of the positive electrode active material is preferably modified by performing heating with a lid put on the container after the fluoride is mixed. The timing for putting the lid can be any one of the following: the lid is put to cover the container before heating and then the container is placed in the heating furnace; the lid is put to cover the container after the container is placed in the heating furnace; and the lid is put during heating before the fluoride is melted.

By the above formation method, the positive electrode active material particle can contain fluorine and the fluorine can improve the wettability of the surface of the positive electrode active material for higher uniformity and flatness. The combination of the positive electrode active material particle obtained in this manner and LiBOB inhibits break of a crystal structure due to repeated charging and discharging at a high voltage, and a secondary battery including the combination of the positive electrode active material particle obtained in this manner and LiBOB can be significantly improved in cycle performance.

Adding too much amount of LiBOB might decrease the initial capacity, and thus the proportion of LiBOB in an electrolyte solution is preferably higher than 0.1 wt % and lower than 3 wt %.

To the positive electrode active material particle having a layered structure, aluminum or magnesium is added to inhibit dissolution of a transition metal, specifically cobalt, so that a region (a surface portion of the particle) including an outer surface of the positive electrode active material particle is strengthen mechanically or chemically. Adding manganese to the outer side of the positive electrode active material particle can also inhibit dissolution of the transition metal, specifically nickel or cobalt.

Note that a secondary battery uses at least a positive electrode, a negative electrode, a conductive material, a separator, an electrolyte solution, and a lithium salt.

Examples of the lithium salt include lithium chloride (LiCl), lithium fluoride (LiF), lithium perchlorate (LiClO₄), lithium tetrafluoroborate (LiBF₄), LiAsF₆, LiPF₆, Li(CF₃SO₃), Li(FSO₂)₂N (what is called LiFSA), and Li(CF₃SO₂)₂N (what is called LiTFSA).

The lithium salt plays a role in promoting movement of Li ions in the electrolyte solution. In view of the compatibility with aluminum used in an electrode, cost, and the like, LiPF₆ is preferably used. However, LiPF₆ is unstable at high temperature and LiPF₆ generates hydrofluoric acid when being decomposed at high temperature, which might cause deterioration of a secondary battery.

As the electrolytic solution, a material that can transfer carrier ions is used. As the solvent of the electrolyte solution, an aprotic organic solvent is preferably used. Typical examples of aprotic organic solvents include ethylene carbonate (EC), propylene carbonate (PC), dimethyl carbonate, diethyl carbonate (DEC), γ-butyrolactone, acetonitrile, dimethoxyethane, and tetrahydrofuran, and one or more of these can be used. When a gelled high-molecular material is used as the solvent of the electrolyte solution, safety against liquid leakage and the like is improved. Furthermore, a storage battery can be thinner and more lightweight. Typical examples of gelled high-molecular materials include a silicone gel, an acrylic gel, an acrylonitrile gel, a polyethylene oxide-based gel, a polypropylene oxide-based gel, and a gel of a fluorine-based polymer.

Among the electrolyte solutions, ethylene carbonate (EC) and diethyl carbonate (DEC) are preferable because of their high heat resistances.

In the case where a first coating film is formed on a surface of the positive electrode active material and a second coating film is formed on a surface of a negative electrode active material with the use of LiBOB as an additive agent, dissolution of a transition metal, decomposition of LiPF₆, and decomposition of the electrolyte solution can be prevented. When charging and discharging are performed at high temperature under a high voltage condition of 4.5 V or higher, dissolution of the transition metal and decomposition of LiPF₆ might be caused. The first coating film and the second coating film are hardly formed right after fabrication of a secondary battery cell, and formed after charging and discharging of the secondary battery using electric charges generated at the time of charging and discharging. In the case where electric conduction is made for degasification in the fabrication of the secondary battery cell, that is, what is called aging treatment is performed, the coating films are formed at the time of making the electric conduction in some cases.

Hydrofluoric acid generated by slight decomposition of LiPF₆ sometimes contributes to formation of a high-quality coating film at an interface of the negative electrode. Fluoride ions generated by decomposition of LiPF₆ prevent corrosion of aluminum, particularly pitting corrosion of aluminum used for a positive electrode by a high-quality coating film.

Such a combination structure in which the positive electrode active material that can be charged at a high voltage and LiBOB are combined can have a prominent synergy, by which stability at high temperature can be ensured even when LiPF₆ that is a lithium salt is used and an effect of significantly improving the cycle performance at high temperature can be obtained.

### Effect of the Invention

The cycle performance of a secondary battery at a charge voltage of 4.5 V at 45° C. or 60° C. can be improved. Accordingly, a power storage device with good cycle performance in rapid charging, little deterioration at high temperature, and little deterioration at a high charge voltage can be achieved.

### BRIEF DESCRIPTION OF THE DRAWINGS

FIG. TA and FIG. 1B are diagrams showing cycle performance of secondary batteries.

FIG. 2 is a graph showing a relationship between an addition amount and a discharge capacity.

FIG. 3 is an example of a formation flow of a positive electrode active material of one embodiment of the present invention.

FIG. 4 is an example of a formation flow of a positive electrode active material of one embodiment of the present invention.

FIG. 5A, FIG. 5B, and FIG. 5C are diagrams illustrating a fabrication example of a secondary battery.

FIG. 6A and FIG. 6B are diagrams illustrating laminated secondary batteries.

FIG. 7A is a top view of a positive electrode, FIG. 7B is a top view of a negative electrode, and FIG. 7C is a diagram illustrating a stacked body.

FIG. 8A is a top view of a laminated secondary battery, and FIG. 8B is a diagram illustrating a cross-sectional view.

FIG. 9A is a perspective view of a secondary battery, FIG. 9B is a cross-sectional perspective view of the secondary battery, FIG. 9C is a perspective view of a battery pack including a plurality of secondary batteries, and FIG. 9D is a top view of the battery pack.

FIG. 10 is a diagram showing crystal structures and magnetism of a positive electrode active material.

FIG. 11 is a diagram showing crystal structures and magnetism of a positive electrode active material of a conventional example.

FIG. 12A, FIG. 12B, FIG. 12C, FIG. 12D, and FIG. 12E are perspective views illustrating electronic devices.

FIG. 13 is a phase diagram showing a relationship between temperature and compositions of lithium fluoride and magnesium fluoride.

FIG. 14A is a model diagram illustrating positive electrode active materials in a secondary battery and a state of an electrolyte solution, an additive agent, and the like that are placed around the positive electrode active materials, and FIG. 14B is a model diagram illustrating a conventional example.

FIG. 15 is a diagram showing chemical reaction formulae.

FIG. 16 is a diagram showing a chemical reaction formula.

FIG. 17A shows a chemical formula representing a kind of lithium salt, FIG. 17B, FIG. 17C, and FIG. 17D are each a chemical formula representing an electrolyte solution, FIG. 17E is a chemical formula representing an additive agent, and FIG. 17F and FIG. 17G are each a chemical formula representing an electrolyte solution.

FIG. 18 is a model diagram illustrating an enlarged part of a secondary battery of one embodiment of the present invention.

FIG. 19 is a diagram showing cycle performance of a secondary battery.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

A secondary battery of this embodiment includes a positive electrode active material containing lithium, a transition metal, magnesium, oxygen, and fluorine, and an electrolyte solution containing lithium bis(oxalato)borate (LiBOB). The transition metal is at least one of cobalt, nickel, and manganese. The positive electrode active material further contains aluminum. The electrolyte solution contains a lithium salt, and diethyl carbonate and ethylene carbonate that dissolve the lithium salt. The lithium salt is lithium hexafluorophosphate. A negative electrode active material is artificial graphite. A mixture in which a conductive material is added to the positive electrode active material may be used, and as the conductive material, acetylene black (AB), VGCF (registered trademark), or a graphene oxide compound may be used. In particular, a graphene oxide compound is preferable because it has a small surface area and can inhibit decomposition of the electrolyte solution.

A graphene compound has excellent electrical characteristics of high conductivity and excellent physical properties of high flexibility and high mechanical strength in some cases. A graphene compound has a planar shape. A graphene compound enables surface contact with low contact resistance. Furthermore, a graphene compound has extremely high conductivity even with a small thickness in some cases and thus allows a conductive path to be formed in an active material layer efficiently even with a small amount. Hence, a graphene compound is preferably used as the conductive additive, in which case the area where the active material and the conductive additive are in contact with each other can be increased. In addition, a graphene compound is preferable because electrical resistance can be reduced in some cases. Here, examples of the graphene compound include graphene, multilayer graphene, multi graphene, graphene oxide, multilayer graphene oxide, multi graphene oxide, reduced graphene oxide, reduced multilayer graphene oxide, reduced multi graphene oxide, and graphene quantum dots. The reduced graphene oxide is hereinafter also referred to as RGO. Note that RGO refers to a compound obtained by reducing graphene oxide (GO), for example. In the case of using an active material particle with a small particle diameter, e.g., 1 μm or less, the specific surface area of the active material particle is large and thus more conductive paths for connecting the active material particles are needed. In such a case, it is particularly preferable to use a graphene compound that can efficiently form a conductive path even with a small amount. In this specification and the like, graphene oxide contains carbon and oxygen, has a sheet-like shape, and includes a functional group, in particular, an epoxy group, a carboxy group, or a hydroxy group. In addition, the plurality of graphene compounds are bonded to each other, thereby forming a net-like graphene compound sheet (hereinafter referred to as a graphene compound net or a graphene net). The graphene net covering the active material can function as a binder for bonding active materials. The amount of binder can thus be reduced, or the binder does not have to be used. This can increase the proportion of the active material in the electrode volume or the electrode weight. That is, the capacity of the secondary battery can be increased.

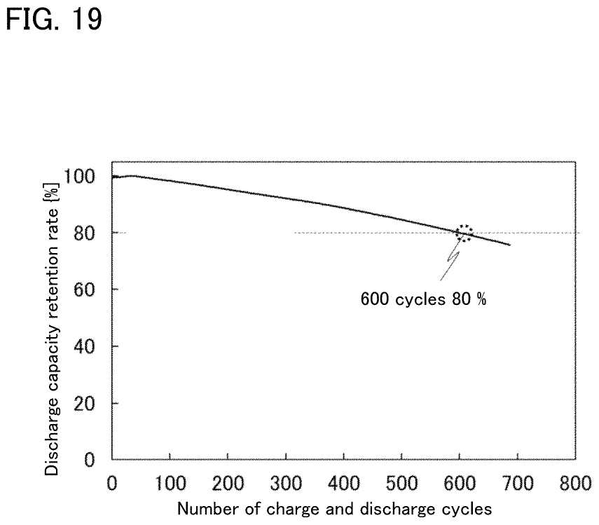

FIG. 1A and FIG. 1B each show the cycle performance of secondary batteries including a positive electrode active material containing lithium, cobalt, nickel, aluminum, oxygen, and fluorine, and an electrolyte solution containing lithium bis(oxalato)borate at 1 wt %. FIG. 1A is the cycle performance under the charge conditions of 45° C. and 4.5 V, and FIG. 1B is the cycle performance under the charge conditions of 60° C. and 4.5 V. FIG. 19 shows the results with the horizontal axis representing the number of charge cycles up to 800, and the results indicate that the number of cycles corresponding to a retention rate of 80% is 600 cycles. Note that the portion up to 300 cycles in FIG. 19 corresponds to FIG. 1A.

In FIG. 1A, the cycle performance is evaluated under the cycle conditions of CCCV charging (0.5C, 4.5V, a termination current of 0.2 C) and CC discharging (0.5 C, 3.0 V) at 45° C. In FIG. 1B, the cycle performance is evaluated under the cycle conditions of CCCV charging (0.5 C, 4.5 V, a termination current of 0.2 C) and CC discharging (0.5 C, 3 V) at 60° C. Note that in FIG. 1A, the initial discharge capacity of a secondary battery with an additive agent is 191.4 mAh/g.

Note that the electrolyte solution of these secondary batteries contain, in addition to LiBOB, lithium hexafluorophosphate that is a lithium salt, and diethyl carbonate and ethylene carbonate that dissolve the lithium salt. The ratio of ethylene carbonate to diethyl carbonate is 3:7.

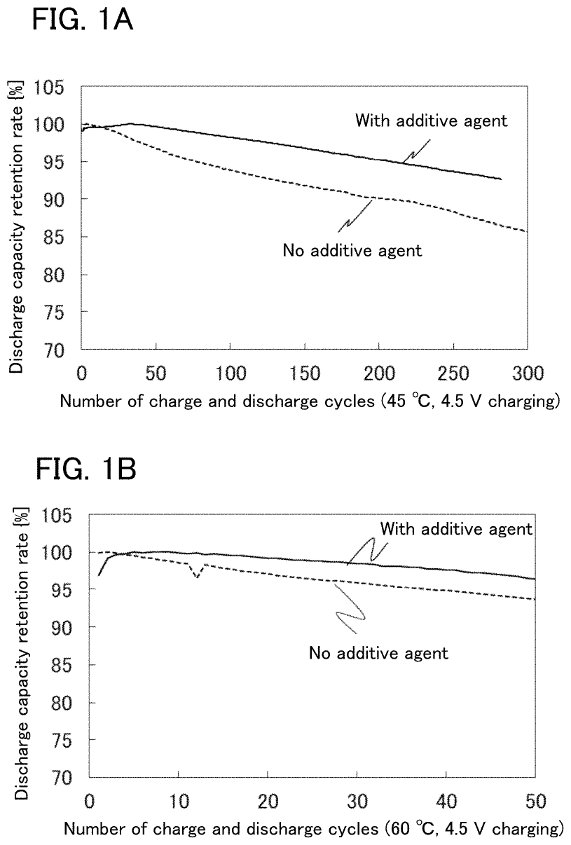

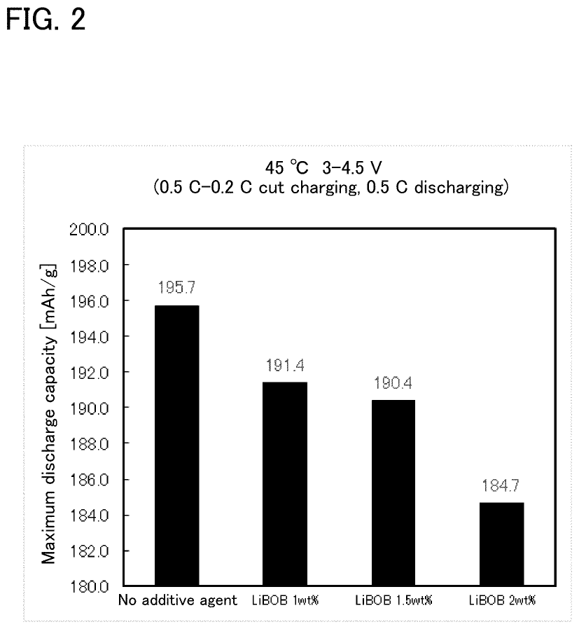

LiBOB that is an additive agent is difficult to dissolve in a solvent; thus, as shown in FIG. 2, the discharge capacity decreases as the addition amount increases. FIG. 2 shows a graph showing, with its vertical axis, values of maximum discharge capacity of a secondary battery with no additive agent, a secondary battery containing LiBOB at 1 wt %, a secondary battery containing LiBOB at 1.5 wt %, and a secondary battery containing LiBOB at 2 wt %. Note that FIG. 2 shows results obtained when charging is performed at 45° C. and 0.5 C to 0.2 C from 3 V to 4.5 V, and discharging is performed at 0.5 C after the voltage reaches a cut-off voltage. Since LiBOB might precipitate at low temperature when being added in too much amount, the proportion of LiBOB in the electrolyte solution is preferably higher than 0.1 wt % and lower than 3 wt %. The positive electrode active material also has characteristics; the positive electrode active material contains lithium, cobalt, magnesium, aluminum, nickel, oxygen, and fluorine. With the combination of the positive electrode active material, the electrolyte solution, and the additive agent, the significant effect can be obtained as shown in FIG. 1.

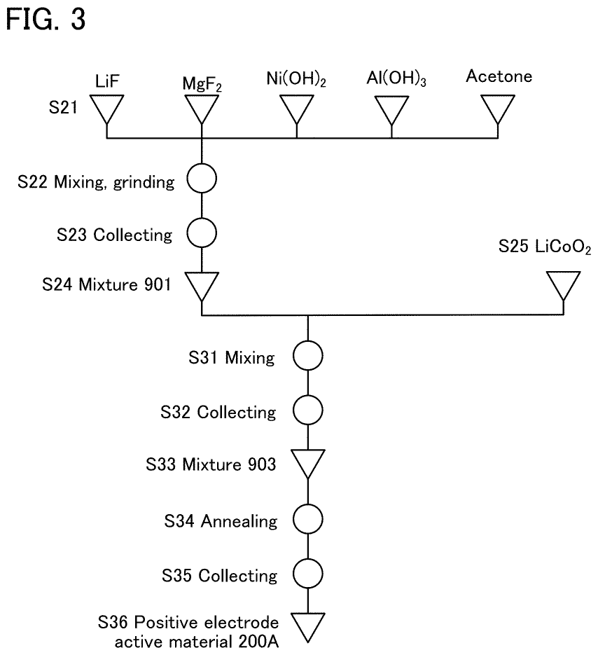

Formation of the positive electrode active material will be described below using a formation flow shown in FIG. 3.

### <Step S21>

First, a halogen source such as a fluorine source or a chlorine source, a magnesium source, a nickel source, and an aluminum source are prepared as materials of a mixture 901. In addition, a lithium source is preferably prepared as well.

As the fluorine source, lithium fluoride, magnesium fluoride, or the like can be used, for example. Among them, lithium fluoride, which has a relatively low melting point of 848° C., is preferable because it is easily melted in an annealing process described later. As the chlorine source, lithium chloride, magnesium chloride, or the like can be used, for example. As the magnesium source, magnesium fluoride, magnesium oxide, magnesium hydroxide, magnesium carbonate, or the like can be used, for example. As the lithium source, lithium fluoride or lithium carbonate can be used, for example. That is, lithium fluoride can be used as both the lithium source and the fluorine source. Magnesium fluoride can be used as both the fluorine source and the magnesium source.

In this embodiment, lithium fluoride LiF is prepared as the fluorine source and the lithium source, and magnesium fluoride MgF₂ is prepared as the fluorine source and the magnesium source (Step S21 in FIG. 3).

When lithium fluoride LiF and magnesium fluoride MgF₂ are mixed at LiF:MgF₂=approximately 65:35 (molar ratio), the effect of lowering the melting point is maximized. On the other hand, when the amount of lithium fluoride increases, excessive lithium might deteriorate cycle performance. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), and still further preferably LiF:MgF₂=x:1 (x=the neighborhood of 0.33).

As the nickel source, nickel hydroxide (Ni(OH)₂) can be used, for example. In this case, the nickel source is preferably pulverized. For example, nickel hydroxide is mixed and ground in a ball mill, a bead mill, or the like using acetone as a solvent, so that pulverized nickel hydroxide can be obtained.

As the aluminum source, aluminum hydroxide (Al(OH)₃) can be used, for example. The aluminum source is preferably pulverized. For example, aluminum hydroxide is mixed and ground in a ball mill, a bead mill, or the like using acetone as a solvent, so that pulverized aluminum hydroxide can be obtained.

In the case where the following mixing and grinding step is performed by a wet process, a solvent is prepared. As the solvent, ketone such as acetone; alcohol such as ethanol or isopropanol; ether; dioxane; acetonitrile; N-methyl-2-pyrrolidone (NMP); or the like can be used. An aprotic solvent that hardly reacts with lithium is further preferably used. In this embodiment, acetone is used (see Step S21 in FIG. 3).

### <Step S22>

Next, the materials of the mixture 901 are mixed and ground (Step S22 in FIG. 3). Although the mixing can be performed by a dry process or a wet process, the wet process is preferable because the materials can be ground to a smaller size. For example, a ball mill, a bead mill, or the like can be used for the mixing. In the base where the ball mill is used, a zirconia ball is preferably used as media, for example. The mixing and grinding step is preferably performed sufficiently to pulverize the mixture 901.

The mixing is preferably performed with a blender, a mixer, or a ball mill.

### <Step S23, Step S24>

The materials mixed and ground in the above manner are collected (Step S23 in FIG. 3), whereby the mixture 901 is obtained (Step S24 in FIG. 3).

The mixture 901 preferably has a median diameter (D50) of, for example, greater than or equal to 600 nm and less than or equal to 20 μm, further preferably greater than or equal to 1 μm and less than or equal to 10 μm. When mixed with a composite oxide containing lithium, a transition metal, and oxygen in a later step, the mixture 901 pulverized to such a small size is easily attached to surfaces of the composite oxide particles uniformly. The mixture 901 is preferably attached to the surfaces of the composite oxide particles uniformly, in which case halogen and magnesium are easily distributed to the surface portion of the composite oxide particles thoroughly after heating. When there is a region containing neither halogen nor magnesium in the surface portion, the above-described pseudo-spinel crystal structure might be less likely to be obtained in a charged state.

### <Step S25>

A composite oxide containing lithium, a transition metal, and oxygen which is synthesized in advance is used in Step S25.

In the case where the composite oxide containing lithium, the transition metal, and oxygen which is synthesized in advance is used, a composite oxide with few impurities is preferably used. In this specification and the like, lithium, cobalt, nickel, manganese, aluminum, and oxygen are the main components of the composite oxide containing lithium, the transition metal, and oxygen and the positive electrode active material, and elements other than the main components are regarded as impurities. For example, when analyzed with a glow discharge mass spectroscopy method, the total impurity concentration is preferably lower than or equal to 10000 ppm wt, further preferably lower than or equal to 5000 ppm wt. In particular, the total impurity concentration of arsenic and transition metals such as titanium is preferably lower than or equal to 3000 ppm wt, further preferably lower than or equal to 1500 ppm wt.

For example, as lithium cobalt oxide synthesized in advance, a lithium cobalt oxide particle (product name: CELLSEED C-10N) formed by NIPPON CHEMICAL INDUSTRIAL CO., LTD. can be used. This is lithium cobalt oxide in which the median diameter (D50) is approximately 12 μm, and in the impurity analysis by a glow discharge mass spectroscopy method (GD-MS), the magnesium concentration and the fluorine concentration are lower than or equal to 50 ppm wt, the calcium concentration, the aluminum concentration, and the silicon concentration are lower than or equal to 100 ppm wt, the nickel concentration is lower than or equal to 150 ppm wt, the sulfur concentration is lower than or equal to 500 ppm wt, the arsenic concentration is lower than or equal to 1100 ppm wt, and the concentrations of elements other than lithium, cobalt, and oxygen are lower than or equal to 150 ppm wt.

The composite oxide containing lithium, the transition metal, and oxygen in Step S25 preferably has a layered rock-salt crystal structure with few defects and distortions. Therefore, the composite oxide preferably includes few impurities. In the case where the composite oxide containing lithium, the transition metal, and oxygen includes a lot of impurities, the crystal structure is highly likely to have a lot of defects or distortions.

### <Step S31>

Next, the mixture 901 and the composite oxide containing lithium, the transition metal, and oxygen are mixed (Step S31 in FIG. 3). The ratio of the atomic number TM of the transition metal in the composite oxide containing lithium, the transition metal, and oxygen to the atomic number MgMix1 of magnesium contained in the mixture 902 is preferably TM:MgMix=1:y (0.005≤y≤0.05), further preferably TM:MgMix=1:y (0.007≤y≤0.04), still further preferably TM:MgMix=approximately 1:0.02.

The condition of the mixing in Step S31 is preferably milder than that of the mixing in Step S22 in order not to damage the particles of the composite oxide. For example, a condition with a lower rotation frequency or shorter time than the mixing in Step S22 is preferable. In addition, it can be said that the dry process has a milder condition than the wet process. For example, a ball mill, a bead mill, or the like can be used for the mixing. In the case where the ball mill is used, a zirconia ball can be used as media, for example.

The materials mixed in the above manner are collected (Step S32 in FIG. 3), whereby a mixture 903 is obtained (Step S33 in FIG. 3).

Next, the mixture 903 is heated (Step S34 in FIG. 3). This step is sometimes referred to as annealing or baking. LiMO₂ is formed by the annealing. Thus, the conditions of performing Step S34, such as temperature, time, an atmosphere, and weight of the mixture 903 on which the annealing is performed, are important. In this specification, annealing includes, in meaning, a case where the mixture 903 is heated and a case where a heating furnace in which at least the mixture 903 is provided is heated. A heating furnace in this specification is equipment used for performing heat treatment (annealing) on a substance or a mixture and includes a heater and an inner wall that can withstand an atmosphere containing a fluoride and at least 600° C. Furthermore, the heating furnace may be provided with a pump having a function of reducing and/or applying pressure in the heating furnace. For example, pressure may be applied during the annealing in S34.

The annealing temperature in S34 needs to be higher than or equal to a temperature at which reaction between the lithium cobalt oxide (S25) and the fluoride proceeds. The temperature at which the reaction proceeds is a temperature that causes interactive diffusion of elements contained in the lithium cobalt oxide and the fluoride. Thus, the temperature may be lower than the melting temperature of these materials. For example, in an oxide, solid phase diffusion occurs at a Tamman temperature Td (0.757 times the melting temperature Tm). Thus, the temperature can be higher than or equal to 500° C., for example.

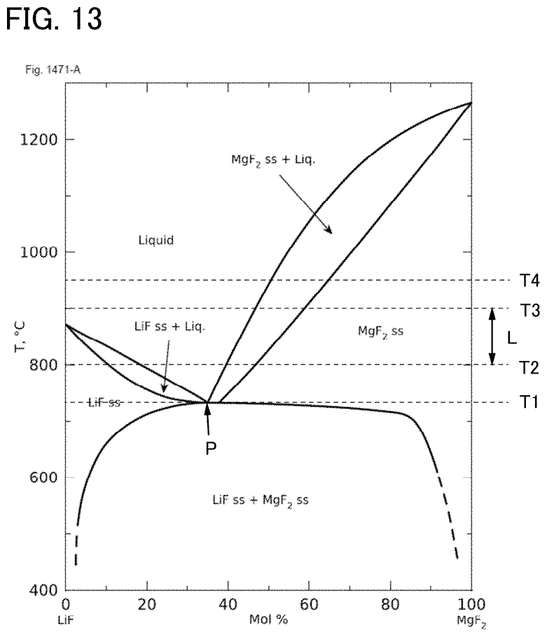

Note that the temperature is preferably higher than or equal to a temperature at which at least part of the mixture 903 is melted, in which case the reaction proceeds more easily. Thus, the annealing temperature is preferably higher than or equal to the eutectic point of the fluoride. In the case where the fluoride contains LiF and MgF₂, the eutectic point P of LiF and MgF₂ is around 742° C. (T1) as shown in FIG. 13 (corrected after being cited from Non-Patent Document 1, FIG. 1471-A); thus, the annealing temperature in S34 is preferably set higher than or equal to 742° C.

A higher annealing temperature in S34 is preferable because it facilitates the reaction, shortens the annealing time, and enables high productivity.

Note that the annealing temperature needs to be lower than or equal to a decomposition temperature of LiCoO₂ (1130° C.). Since the decomposition temperature of LiCoO₂ is 1130° C., decomposition of a slight amount of LiCoO₂ is concerned at a temperature close to the decomposition temperature. Thus, the annealing temperature is preferably lower than or equal to 1130° C., further preferably lower than or equal to 1000° C., still further preferably lower than or equal to 950° C., yet further preferably lower than or equal to 900° C.

In view of the above, the annealing temperature is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet further preferably higher than or equal to 500° C. and lower than or equal to 900° C. Furthermore, the annealing temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet further preferably higher than or equal to 742° C. and lower than or equal to 900° C. Furthermore, the annealing temperature is preferably higher than or equal to 800° C. and lower than or equal to 1130° C., further preferably higher than or equal to 800° C. and lower than or equal to 1000° C., still further preferably higher than or equal to 800° C. and lower than or equal to 950° C., most preferably higher than or equal to 800° C. (T2) and lower than or equal to 900° C. (T3) (a range L). Furthermore, the annealing temperature is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet further preferably higher than or equal to 830° C. and lower than or equal to 900° C.

Specifically, LiF is used as the fluoride and the annealing in S34 is performed with a lid put on a container, so that a positive electrode active material with favorable cycle performance or the like can be formed. The use of LiF and MgF₂ as the fluoride is considered to facilitate reaction with LiCoO₂ and generate LiMO₂.

In this embodiment, LiF that is a fluoride is considered to function as flux. Since the inner capacity of the heating furnace is larger than the capacity of the container and LiF is lighter than oxygen, it is probable that generation of LiMO₂ is inhibited when LiF is volatized and the amount of LiF in the mixture 903 is decreased. Therefore, heating needs to be performed while volatilization of LiF is inhibited. Even when LiF is not used, Li and F in the surface of the lithium cobalt oxide might react with each other to generate LiF and cause volatilization. Therefore, the volatilization needs to be inhibited also when a fluoride having a higher melting point than LiF is used.

In view of this, the mixture 903 is heated in an atmosphere containing LiF, that is, the mixture 903 is heated in a state where the partial pressure of LiF in the heating furnace is high, whereby volatilization of LiF in the mixture 903 can be inhibited. When annealing is performed using a fluoride (LiF or MgF) to form an eutectic mixture with a lid put on the container, the annealing temperature can be lowered to the decomposition temperature (1130° C.) or lower of LiCoO₂, specifically, a temperature higher than or equal to 742° C. and lower than or equal to 1000° C., which can promote generation of LiMO₂ efficiently. Accordingly, a positive electrode active material having excellent characteristics can be formed, and the annealing time can be shortened.

The annealing in Step S34 is preferably performed at an appropriate temperature for an appropriate time. The appropriate temperature and time depend on the conditions such as the particle size and the composition of the lithium cobalt oxide particle (S25). In the case where the particle is small, sometimes the annealing is preferably performed at a lower temperature or for a shorter time than the case where the particle is large. A step of removing the lid is included after the annealing in S34.

In the case where the median diameter (D50) of particles of the lithium cobalt oxide (S25) is approximately 12 μm, for example, the annealing time is preferably 3 hours or longer, further preferably 10 hours or longer, for example.

By contrast, in the case where the median diameter (D50) of particles of the lithium cobalt oxide (S25) is approximately 5 μm, the annealing time is preferably longer than or equal to 1 hour and shorter than or equal to 10 hours, further preferably approximately 2 hours, for example.

The temperature decreasing time after the annealing is preferably longer than or equal to 10 hours and shorter than or equal to 50 hours, for example.

The material annealed in the above manner is collected (Step S35 in FIG. 3). Then, the particles are preferably made to pass through a sieve. Through the above steps, a positive electrode active material 200A of one embodiment of the present invention can be formed (Step S36 in FIG. 3).

The structure of the positive electrode active material is not limited to the above; even when the positive electrode active material uses neither nickel nor aluminum, a prominent effect can be obtained with the combination of the positive electrode active material, the electrolyte solution, and the additive agent.

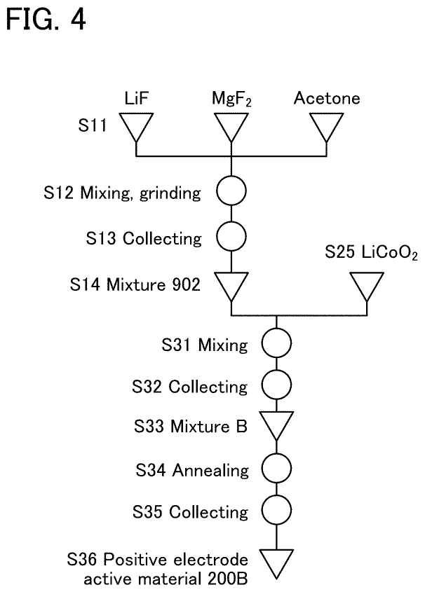

Another formation example of a positive electrode active material that uses neither nickel nor aluminum will be described below using a formation flow shown in FIG. 4.

As shown in Step S11 in FIG. 4, lithium fluoride that is a fluorine source and magnesium fluoride that is a magnesium source are first prepared as materials of the mixture 902. Lithium fluoride, which has a relatively low melting point of 848° C., is preferable because it is easily melted in an annealing process described later. Lithium fluoride can be used as both the lithium source and the fluorine source. Magnesium fluoride can be used as both the fluorine source and the magnesium source.

In FIG. 4, lithium fluoride LiF is prepared as the fluorine source and the lithium source, and magnesium fluoride MgF₂ is prepared as the fluorine source and the magnesium source (Step S11 in FIG. 4). The molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=the neighborhood of 0.33).

In addition, in the case where the following mixing and grinding step is performed by a wet process, a solvent is prepared. As the solvent, ketone such as acetone; alcohol such as ethanol or isopropanol; ether; dioxane; acetonitrile; N-methyl-2-pyrrolidone (NMP); or the like can be used. An aprotic solvent that hardly reacts with lithium is further preferably used. In this embodiment, acetone is used (see Step S11 in FIG. 4).

Next, the materials of the mixture 902 are mixed and ground (Step S12 in FIG. 4). Although the mixing can be performed by a dry process or a wet process, the wet process is preferable because the materials can be ground to a smaller size. For example, a ball mill, a bead mill, or the like can be used for the mixing. When the ball mill is used, a zirconia ball can be used as media, for example. The mixing and grinding step is preferably performed sufficiently to pulverize the mixture 902.

The materials mixed and ground in the above manner are collected (Step S13 in FIG. 4), whereby the mixture 902 is obtained (Step S14 in FIG. 4).

For example, the D50 of the mixture 902 is preferably greater than or equal to 600 nm and less than or equal to 20 μm, further preferably greater than or equal to 1 μm and less than or equal to 10 μm. When mixed with a composite oxide containing lithium, a transition metal, and oxygen in a later step, the mixture 902 pulverized to such a small size is easily attached to surfaces of the composite oxide particles uniformly. The mixture 902 is preferably attached to the surfaces of the composite oxide particles uniformly because both halogen and magnesium are easily distributed to the surface portion of the composite oxide particles after heating. When there is a region containing neither halogen nor magnesium in the surface portion, the above-described pseudo-spinel crystal structure might be less likely to be obtained in a charged state.

Next, a lithium source is prepared as shown in Step S25. A composite oxide containing lithium, a transition metal, and oxygen which is synthesized in advance is used in Step S25.

For example, as lithium cobalt oxide synthesized in advance, a lithium cobalt oxide particle (product name: CELLSEED C-10N) formed by NIPPON CHEMICAL INDUSTRIAL CO., LTD. can be used. This is lithium cobalt oxide in which the median diameter (D50) is approximately 12 μm, and in the impurity analysis by a glow discharge mass spectroscopy method (GD-MS), the magnesium concentration and the fluorine concentration are lower than or equal to 50 ppm wt, the calcium concentration, the aluminum concentration, and the silicon concentration are lower than or equal to 100 ppm wt, the nickel concentration is lower than or equal to 150 ppm wt, the sulfur concentration is lower than or equal to 500 ppm wt, the arsenic concentration is lower than or equal to 1100 ppm wt, and the concentrations of elements other than lithium, cobalt, and oxygen are lower than or equal to 150 ppm wt.

The composite oxide containing lithium, the transition metal, and oxygen in Step S25 preferably has a layered rock-salt crystal structure with few defects and distortions. Therefore, the composite oxide preferably includes few impurities. In the case where the composite oxide containing lithium, the transition metal, and oxygen includes a lot of impurities, the crystal structure is highly likely to have a lot of defects or distortions.

Next, the mixture 902 and the composite oxide containing lithium, the transition metal, and oxygen are mixed (Step S31 in FIG. 4). The ratio of the atomic number TM of the transition metal in the composite oxide containing lithium, the transition metal, and oxygen to the atomic number MgMix1 of magnesium contained in the mixture 902 is preferably TM:MgMix=1:y (0.005≤y≤0.05), further preferably TM:MgMix=1:y (0.007≤y≤0.04), still further preferably TM:MgMix=approximately 1:0.02.

The condition of the mixing in Step S31 is preferably milder than that of the mixing in Step S12 in order not to damage the particles of the composite oxide. For example, a condition with a lower rotation frequency or shorter time than the mixing in Step S12 is preferable. In addition, it can be said that the dry process has a milder condition than the wet process. For example, a ball mill, a bead mill, or the like can be used for the mixing. In the case where the ball mill is used, a zirconia ball can be used as media, for example.

The materials mixed in the above manner are collected (Step S32 in FIG. 4), whereby a mixture B is obtained (Step S33 in FIG. 4).

Next, the mixture B is heated (Step S34 in FIG. 4).

The annealing is preferably performed at an appropriate temperature for an appropriate time. The appropriate temperature and time depend on the conditions such as the particle size and the composition of the composite oxide containing lithium, the transition metal, and oxygen in Step S25. In the case where the particle is small, sometimes the annealing is preferably performed at a lower temperature or for a shorter time than in the case where the particle is large.

In the case where the median diameter (D50) of the particles in Step S25 is approximately 12 μm, for example, the annealing temperature is preferably higher than or equal to 600° C. and lower than or equal to 950° C., for example. The annealing time is preferably longer than or equal to 3 hours, further preferably longer than or equal to 10 hours, still further preferably longer than or equal to 60 hours, for example.

In the case where the median diameter (D50) of the particles in Step S25 is approximately 5 μm, the annealing temperature is preferably higher than or equal to 600° C. and lower than or equal to 950° C., for example. The annealing time is preferably longer than or equal to 1 hour and shorter than or equal to 10 hours, further preferably approximately 2 hours, for example.

The temperature decreasing time after the annealing is preferably longer than or equal to 10 hours and shorter than or equal to 50 hours, for example.

It is considered that when the mixture B is annealed, a material having a low melting point (e.g., lithium fluoride, which has a melting point of 848° C.) in the mixture B is melted first and distributed to the surface portion of the composite oxide particle. Next, the existence of the melted material decreases the melting points of other materials, presumably resulting in melting of the other materials. For example, magnesium fluoride (melting point: 1263° C.) is presumably melted and distributed to the surface portion of the composite oxide particle.

The elements contained in the mixture B are diffused faster in the surface portion and the vicinity of the grain boundary than in the inner portion of the composite oxide particle. Therefore, the concentrations of magnesium and halogen are higher in the surface portion and the vicinity of the grain boundary than in the inner portion. As described later, the higher the magnesium concentration in the surface portion and the vicinity of the grain boundary is, the more effectively the change in the crystal structure can be inhibited.

The materials annealed in the above manner are collected (Step S35 in FIG. 4), whereby a positive electrode active material 200B is obtained (Step S36 in FIG. 4).

When a secondary battery uses the positive electrode active material 200B obtained in the above manner and an electrolyte solution to which LiBOB is added, favorable cycle performance results at higher than or equal to 45° C. can be obtained.

### Embodiment 2

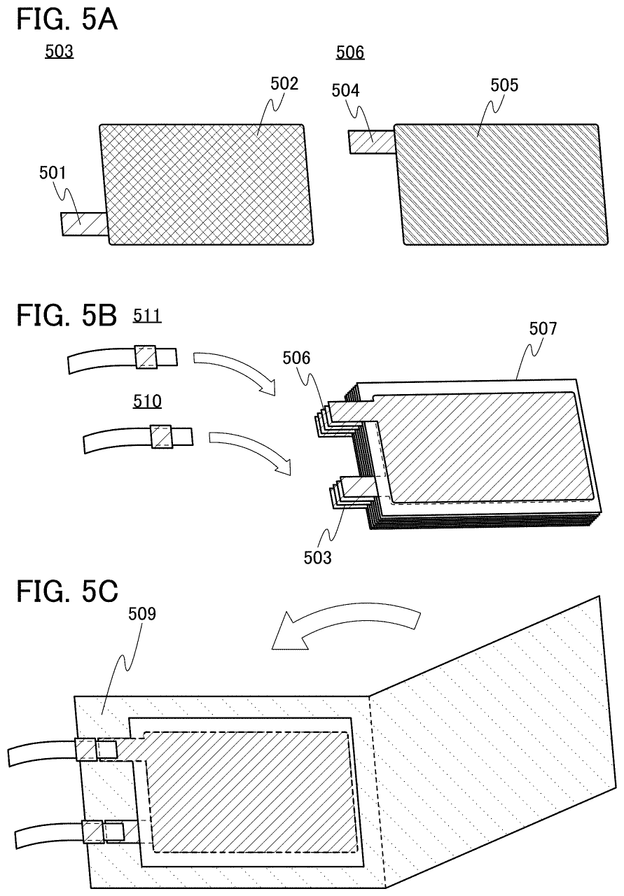

An example of a method for fabricating a laminated secondary battery will be described with reference to FIG. 5B and FIG. 5C.

First, a negative electrode 506, a separator 507, and a positive electrode 503 are stacked.

FIG. 5A shows external views of the positive electrode 503 and the negative electrode 506. The positive electrode 503 includes a positive electrode current collector 501, and a positive electrode active material layer 502 is formed on a surface of the positive electrode current collector 501. A slurry in which the positive electrode active material, acetylene black (AB), and polyvinylidene fluoride (PVDF) are mixed at the positive electrode active material: AB:PVDF=95:3:2 (weight ratio) is applied on the positive electrode current collector 501, and then pressing is performed at a linear pressure of 120 kN/m at 120° C., whereby the positive electrode active material layer 502 is formed. AB is used as a conductive material (also referred to as a conductive additive). Mixing for preparing a slurry is performed in the following manner: first, the active material, AB, and 40% of polyvinylidene fluoride (PVDF) are mixed, stirred until the mixture becomes uniform, the other (60%) of PVDF is added, and NMP is further mixed to adjust viscosity. After the application, drying is performed in a circulation drying furnace at 80° C. for 30 minutes.

The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 5A.

FIG. 5B illustrates the stack of the negative electrode 506, the separator 507, and the positive electrode 503. Illustrated here is an example using five negative electrodes and four positive electrodes. Next, the tab regions of the positive electrodes 503 are bonded to each other, and the tab region of the positive electrode on the outermost surface and a positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and a negative electrode lead electrode 511 are bonded to each other.

After that, the negative electrode 506, the separator 507, and the positive electrode 503 are placed over an exterior body 509.

Subsequently, the exterior body 509 is folded along a portion indicated by a dashed line, as illustrated in FIG. 5C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte solution 508 can be introduced later.

Next, the electrolyte solution 508 is introduced into the exterior body 509 from the inlet of the exterior body 509. The electrolyte solution 508 is preferably introduced in a reduced pressure atmosphere or in an inert gas atmosphere. In this embodiment, 1 mol/l of LiPF₆ is used as a lithium salt, EC and DEC at a ratio of 3:7 (volume ratio) are used as a solvent, and LiBOB at 1 wt % is used as an additive agent; a total of 600 μL is introduced from the inlet. Lastly, the inlet is sealed by bonding. In the above manner, a secondary battery 500 that is the laminated secondary battery can be fabricated.

When the positive electrode active material particle and LiBOB described in the above embodiment are used in the positive electrode 503, the secondary battery 500 with little deterioration and high safety can be obtained.

Next, aging after fabrication of a secondary battery will be described. Aging is preferably performed after fabrication of a secondary battery. An example of aging conditions will be described below. First, charging is performed at a rate of higher than or equal to 0.001 C and lower than or equal to 0.2 C. The temperature can be higher than or equal to room temperature and lower than or equal to 60° C., for example. In the case where the reaction potential of the positive electrode or the negative electrode is out of the range of the potential window of the electrolyte solution 508, the electrolyte solution is decomposed by charging and discharging of a secondary battery in some cases. In the case where a gas is generated due to decomposition of the electrolyte solution and the gas is accumulated in the cell, a region where the electrolyte solution cannot be in contact with a surface of the electrode is generated. That is to say, an effectual reaction area of the electrode is reduced and effectual resistance is increased.

When the resistance is extremely increased, the negative electrode potential is decreased. Consequently, lithium is intercalated into graphite and lithium is precipitated on the surface of graphite. The lithium precipitation might cause reduction of capacity. For example, if a coating film or the like is grown on the surface after lithium precipitation, lithium precipitated on the surface cannot be dissolved again, and the amount of lithium that does not contribute to capacity increases. In addition, also when precipitated lithium is physically collapsed and conduction with the electrode is lost, lithium that does not contribute to capacity is generated. Therefore, degasification is preferably performed before the potential of the negative electrode reaches the potential of lithium because of an increase in charge voltage.

After the degasification is performed, the charge state may be maintained at a temperature higher than room temperature, preferably higher than or equal to 30° C. and lower than or equal to 60° C., further preferably higher than or equal to 35° C. and lower than or equal to 50° C., for example, for longer than or equal to 1 hour and shorter than or equal to 100 hours. In the charging initially performed, an electrolyte solution decomposed on the surface forms a coating film on the surface of graphite. The formed coating film may thus be densified when the charge state is held at a temperature higher than room temperature after the degasification, for example.

An excess electrolyte solution is removed after the degasification in some cases. However, the effect on weight change or the like of the battery is considered to be little because the amount is slight.

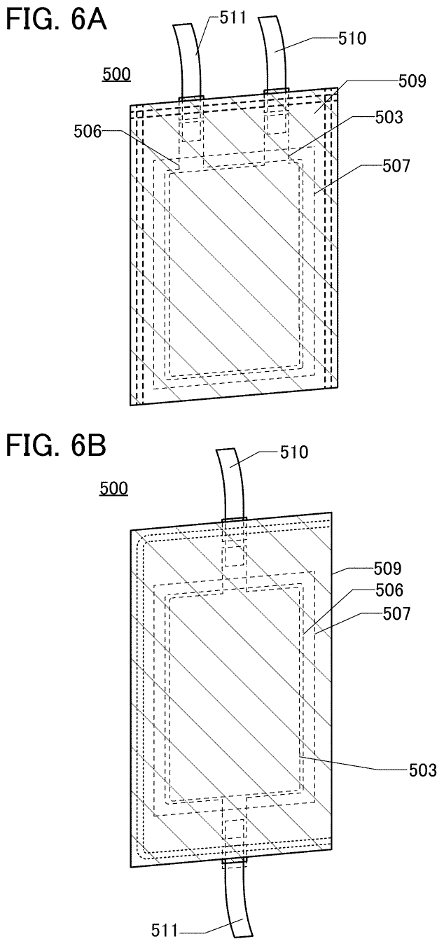

Examples of a laminated secondary battery will be described with reference to FIG. 6A and FIG. 6B.

FIG. 6A illustrates an example of an external view of the laminated secondary battery 500. FIG. 6B illustrates another example of an external view of the laminated secondary battery 500.

In FIG. 6A and FIG. 6B, the laminated secondary battery 500 includes the positive electrode 503, the negative electrode 506, the separator 507, the exterior body 509, the positive electrode lead electrode 510, and the negative electrode lead electrode 511.

The laminated secondary battery 500 includes a plurality of strip-shaped positive electrodes 503, the separator 507, and a plurality of strip-shaped negative electrodes 506.

Although FIG. 5 illustrates an example of a stack, a wound body is used in some cases. In that case, the negative electrode 506 and the positive electrode 503 are stacked to overlap each other with the separator 507 sandwiched therebetween, and the stacked sheet is wound.

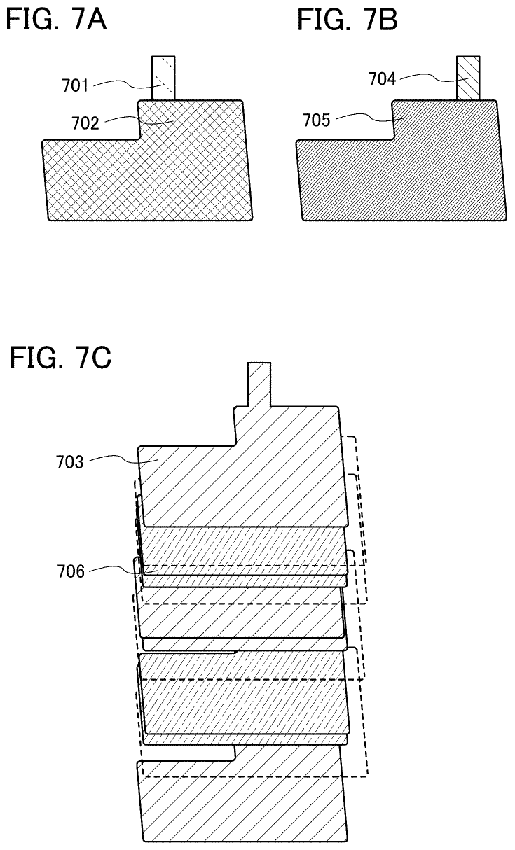

FIG. 7A illustrates a positive electrode including a positive electrode current collector 701 and a positive electrode active material layer 702 that have an L-shape. The positive electrode includes a region where the positive electrode current collector 701 is partly exposed (hereinafter, referred to as a tab region). In addition, FIG. 7B illustrates a negative electrode including a negative electrode current collector 704 and a negative electrode active material layer 705 that have an L-shape. The negative electrode includes a region where the negative electrode current collector 704 is partly exposed, that is, a tab region.

FIG. 7C illustrates a perspective view in which four layers of positive electrodes 703 and four layers of negative electrodes 706 are stacked. Note that in FIG. 7C, separators provided between the positive electrodes 703 and the negative electrodes 706 are indicated by dotted lines for simplicity.

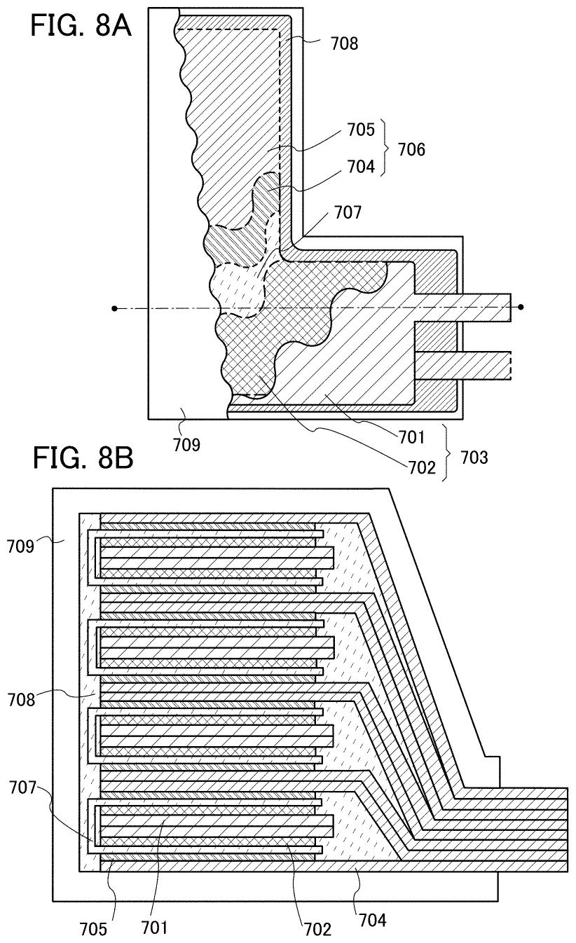

A laminated secondary battery illustrated in FIG. 8A includes a positive electrode 703 including the positive electrode current collector 701 and the positive electrode active material layer 702 that have an L-shape, a negative electrode 706 including the negative electrode current collector 704 and the negative electrode active material layer 705 that have an L-shape, a separator 707, an electrolyte solution 708, and an exterior body 709. The separator 707 is placed between the positive electrode 703 and the negative electrode 706 provided in the exterior body 709. In addition, the inner side of the exterior body 709 is filled with the electrolyte solution 708.

In the laminated secondary battery illustrated in FIG. 8A, the positive electrode current collector 701 and the negative electrode current collector 704 also serve as terminals for electrical contact with the outside. For this reason, parts of the positive electrode current collector 701 and the negative electrode current collector 704 may be placed to be exposed to the outside of the exterior body 709. Alternatively, a lead electrode and the positive electrode current collector 701 or the negative electrode current collector 704 may be bonded to each other by ultrasonic welding, and instead of the positive electrode current collector 701 and the negative electrode current collector 704, the lead electrode may be exposed to the outside of the exterior body 709.

As the exterior body 709 of the laminated secondary battery, for example, a laminate film having a three-layer structure can be used in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 8B illustrates an example of a cross-sectional structure of the laminated secondary battery. Although not illustrated in FIG. 8A for simplicity, actually a plurality of electrode layers are included.

In FIG. 8B, the number of electrode layers is set to 16, for example. FIG. 8B illustrates a structure including eight layers of negative electrode current collectors 704 and eight layers of positive electrode current collectors 701, i.e., 16 layers in total. Note that FIG. 8B illustrates a cross section of a lead portion of the positive electrode, which is cut along the chain line in FIG. 8A, and the eight layers of negative electrode current collectors 704 are bonded to each other by ultrasonic welding. It is needless to say that the number of electrode layers is not limited to 16, and may be more than 16 or less than 16. In the case where the number of electrode layers is large, the secondary battery can have high capacity. In addition, in the case where the number of electrode layers is small, the secondary battery can be thinner.

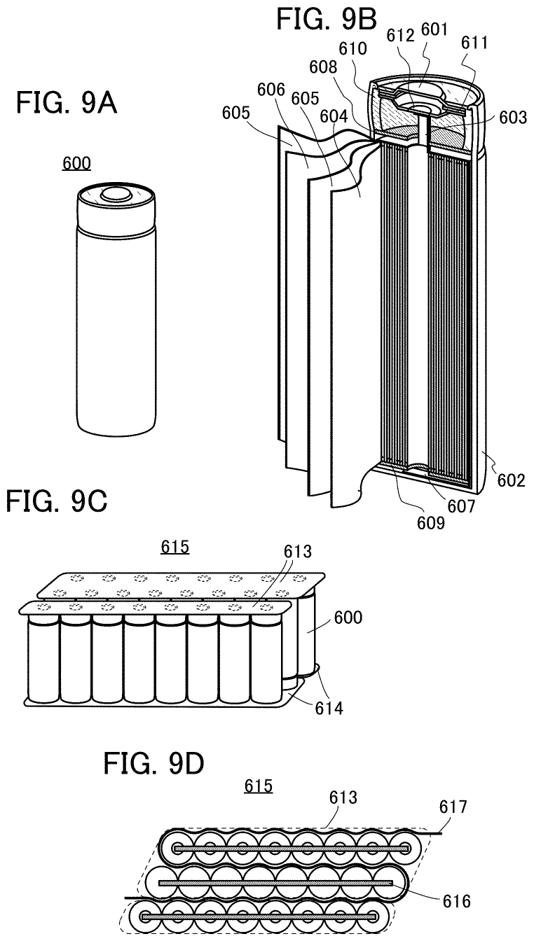

An example of a cylindrical secondary battery will be described with reference to FIG. 9A to FIG. 9D. A cylindrical secondary battery 600 includes, as illustrated in FIG. 9A, a positive electrode cap (battery lid) 601 on the top surface and a battery can (outer can) 602 on the side and bottom surfaces. The positive electrode cap and the battery can (outer can) 602 are insulated from each other by a gasket (insulating gasket) 610.

FIG. 9B is a diagram schematically illustrating a cross-section of the cylindrical secondary battery. Inside the battery can 602 having a hollow cylindrical shape, a battery element in which a strip-like positive electrode 604 and a strip-like negative electrode 606 are wound with a separator 605 sandwiched therebetween is provided. Although not illustrated, the battery element is wound around a center pin. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 are preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte, a nonaqueous electrolyte that is similar to that for a coin-type secondary battery can be used.

Since a positive electrode and a negative electrode that are used for a cylindrical storage battery are wound, active materials are preferably formed on both surfaces of current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. In addition, the PTC element 611 is a thermally sensitive resistor whose resistance increases as temperature rises, and limits the amount of current by increasing the resistance to prevent abnormal heat generation. Barium titanate (BaTiO₃)-based semiconductor ceramics or the like can be used for the PTC element.

Alternatively, as illustrated in FIG. 9C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 9D is a top view of the module 615. The conductive plate 613 is indicated by a dotted line for clarity of the drawing. As illustrated in FIG. 9D, the module 615 may include a wiring 616 electrically connecting the plurality of secondary batteries 600 with each other. It is possible to provide the conductive plate over the wiring 616 to overlap each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be affected by the outside temperature.

When the positive electrode active material formed by the formation method described in the above embodiment is used in the positive electrode 604, the cylindrical secondary battery 600 with little deterioration and high safety can be obtained.

### Embodiment 3

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given. As an example of the element M, one or more elements selected from Co, Ni, and Mn can be given. As another example of the element M, in addition to one or more elements selected from Co, Ni, and Mn, one or more elements selected from Al and Mg can be given.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, in the case where high-voltage charging and discharging are performed on LiNiO₂, the crystal structure might be broken because of the distortion. The influence of the Jahn-Teller effect is suggested to be small in LiCoO₂; hence, LiCoO₂ is preferable because the resistance to high-voltage charging and discharging is higher in some cases.

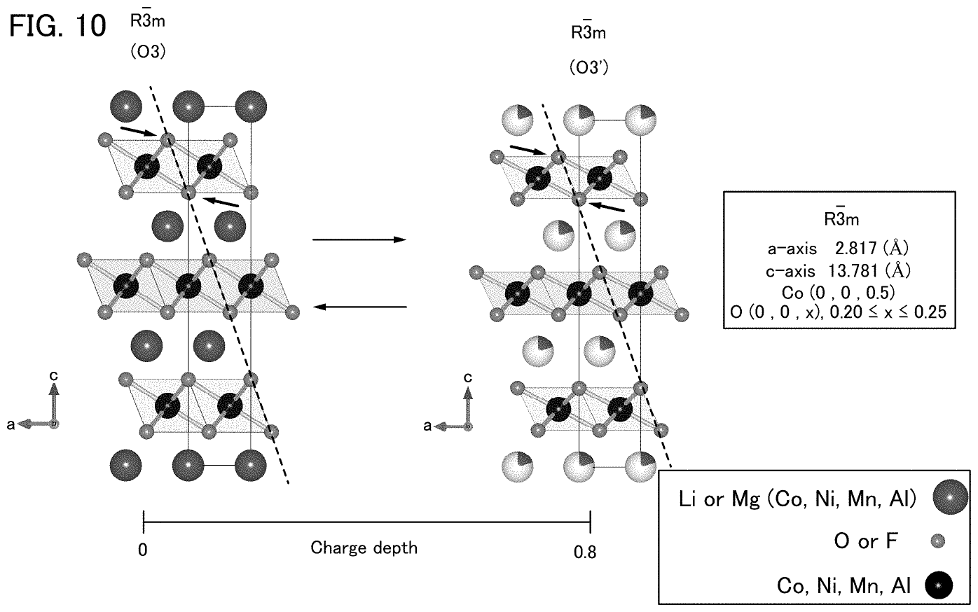

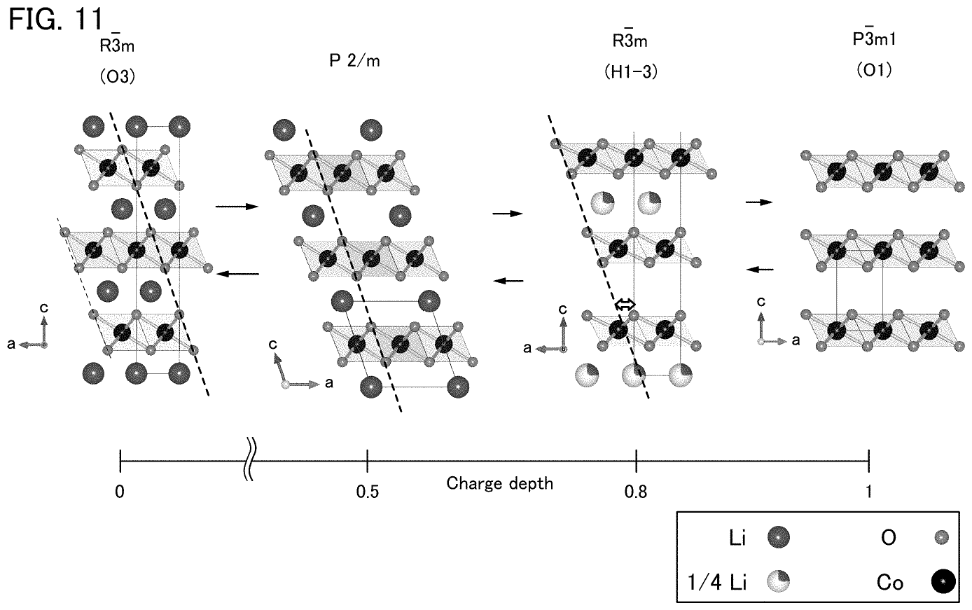

Positive electrode active materials are described with reference to FIG. 10 and FIG. 11. With reference to FIG. 10 and FIG. 11, the case where cobalt is used as a transition metal contained in the positive electrode active material is described.

### <Conventional Positive Electrode Active Material>

A positive electrode active material illustrated in FIG. 11 is lithium cobalt oxide (LiCoO₂) to which halogen and magnesium are not added. The crystal structure of the lithium cobalt oxide illustrated in FIG. 11 changes depending on the charge depth.

As illustrated in FIG. 11, in lithium cobalt oxide with a charge depth of 0 (in a discharged state), there is a region having the crystal structure of the space group R-3m, lithium occupies octahedral sites, and three CoO₂ layers exist in a unit cell. Thus, this crystal structure is referred to as an O3 type crystal structure in some cases. Note that the CoO₂ layer has a structure in which octahedral structure with cobalt coordinated to six oxygen atoms continues on a plane in the edge-sharing state.

When the charge depth is 1, LiCoO₂ has the crystal structure of the space group P-3 ml, and one CoO₂ layer exists in a unit cell. Thus, this crystal structure is referred to as an O1 type crystal structure in some cases.

Moreover, lithium cobalt oxide when the charge depth is approximately 0.8 has the crystal structure of the space group R-3m. This structure can also be regarded as a structure in which CoO₂ structures such as P-3 ml (O1) and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in other structures. However, in this specification including FIG. 11, the c-axis of the H1-3 type crystal structure is described half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell including one cobalt and two oxygen. Meanwhile, the O3′ type crystal structure of one embodiment of the present invention is preferably represented by a unit cell including one cobalt and one oxygen, as described later. This means that the symmetry of cobalt and oxygen differs between the O3′ type crystal structure and the H1-3 type structure, and the amount of change from the O3 structure is smaller in the O3′ type crystal structure than in the H1-3 type structure. A preferred unit cell for representing a crystal structure in a positive electrode active material is selected such that the value of GOF (good of fitness) is smaller in the Rietveld analysis of XRD, for example.

When charging with a high voltage of 4.6 V or higher based on the redox potential of a lithium metal or charging with a large charge depth of 0.8 or more and discharging are repeated, the crystal structure of lithium cobalt oxide changes (i.e., an unbalanced phase change occurs) repeatedly between the H1-3 type crystal structure and the R-3m (O3) structure in a discharged state.

However, there is a large deviation in the CoO₂ layers between these two crystal structures. As indicated by the dotted line and the arrow in FIG. 11, the CoO₂ layer in the H1-3 type crystal structure largely deviates from that in R-3m (O3). Such a dynamic structural change might adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are continuous, such as P-3 ml (O1), included in the H1-3 type crystal structure is highly likely to be unstable.

Thus, the repeated high-voltage charging and discharging break the crystal structure of lithium cobalt oxide. The break of the crystal structure degrades the cycle performance. This is probably because the break of the crystal structure reduces sites where lithium can stably exist and makes it difficult to insert and extract lithium.

### <Positive Electrode Active Material of One Embodiment of the Present Invention>

In a positive electrode active material 904 formed by one embodiment of the present invention, the deviation in CoO₂ layers can be small in repeated high-voltage charging and discharging. Furthermore, the change in the volume can be small. Thus, the compound can have excellent cycle performance. In addition, the compound can have a stable crystal structure in a high-voltage charged state. Thus, in the compound, sometimes a short circuit is less likely to occur while the high-voltage charged state is maintained. This is preferable because the safety is further improved.

The positive electrode active material of one embodiment of the present invention has a small change in the crystal structure and a small difference in volume per the same number of transition metal atoms between a sufficiently discharged state and a high-voltage charged state.

FIG. 10 illustrates the crystal structures of the positive electrode active material 904 of one embodiment of the present invention before and after being charged and discharged. The positive electrode active material 904 is a composite oxide containing lithium, cobalt that is a transition metal, and oxygen. In addition to the above, the positive electrode active material 904 preferably contains magnesium as an additive element. Furthermore, the positive electrode active material 904 preferably contains halogen such as fluorine or chlorine as an additive element.

The crystal structure with a charge depth of 0 (in a discharged state) in FIG. 10 belongs to R-3m (O3) as in FIG. 11. Meanwhile, the positive electrode active material 904 with a charge depth in a sufficiently charged state includes a crystal whose structure is different from the H1-3 type crystal structure. This structure belongs to the space group R-3m, and is not a spinel crystal structure but a structure in which an ion of cobalt, magnesium, or the like is coordinated to six oxygen atoms and the cation arrangement has symmetry similar to that of the spinel crystal structure. Furthermore, the symmetry of CoO₂ layers of this structure is the same as that in the O3 type structure. Thus, in this specification and the like, the structure is referred to as the O3′ type crystal structure or the pseudo-spinel crystal structure. Thus, the O3′ type crystal structure may be referred to as the pseudo-spinel crystal structure. Note that although the indication of lithium is omitted in the diagram of the O3′ type crystal structure illustrated in FIG. 10 to explain the symmetry of cobalt atoms and the symmetry of oxygen atoms, lithium of 20 atomic % or less, for example, with respect to cobalt practically exists between the CoO₂ layers. In addition, in both the O3 type crystal structure and the O3′ type crystal structure, a slight amount of magnesium preferably exists between the CoO₂ layers, i.e., in lithium sites. In addition, a slight amount of halogen such as fluorine preferably exists in oxygen sites at random.

Note that in the O3′ type crystal structure, a light element such as lithium is coordinated to four oxygen atoms in some cases; also in that case, the ion arrangement has symmetry similar to that of the spinel structure.

The O3′ type crystal structure can also be regarded as a crystal structure that contains Li between layers at random but is similar to a CdCl₂ crystal structure. The crystal structure similar to the CdCl₂ crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

In the positive electrode active material 904 of one embodiment of the present invention, a change in the crystal structure when high-voltage charging is performed and a large amount of lithium is released is inhibited as compared with a conventional positive electrode active material. As indicated by dotted lines in FIG. 10, for example, CoO₂ layers hardly deviate in the crystal structures.

More specifically, the structure of the positive electrode active material 904 of one embodiment of the present invention is highly stable even when a charge voltage is high. For example, a conventional positive electrode active material has the H1-3 type crystal structure at a charge voltage of approximately 4.6 V with reference to the potential of a lithium metal; however, the positive electrode active material 904 of one embodiment of the present invention can maintain the crystal structure of R-3m (O3) even at the charge voltage of approximately 4.6 V. The positive electrode active material 904 of one embodiment of the present invention can have the O3′ crystal structure even at a higher charge voltage, e.g., approximately 4.65 V to 4.7 V with reference to the potential of a lithium metal. When the charge voltage is further increased to be higher than 4.7 V, sometimes the H1-3 type crystal is eventually observed in the positive electrode active material 904 of one embodiment of the present invention. In addition, the positive electrode active material 904 of one embodiment of the present invention might have the O3′ type crystal structure even at a lower charge voltage (e.g., a charge voltage of higher than or equal to 4.5 V and lower than 4.6 V with reference to the potential of a lithium metal).

Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with reference to the potential of a lithium metal. Thus, even in a secondary battery that contains graphite as a negative electrode active material and has a voltage of higher than or equal to 4.3 V and lower than or equal to 4.5 V, for example, the positive electrode active material 904 of one embodiment of the present invention can maintain the crystal structure of R-3m (O3) and moreover, can have the O3′ type crystal structure at higher voltages, e.g., a voltage of the secondary battery of higher than 4.5 V and lower than or equal to 4.6 V. In addition, the positive electrode active material 904 of one embodiment of the present invention can have the O3′ type crystal structure at lower charge voltages, e.g., at a voltage of the secondary battery of higher than or equal to 4.2 V and lower than 4.3 V, in some cases.

Thus, in the positive electrode active material 904 of one embodiment of the present invention, the crystal structure is less likely to be broken even when charging and discharging are repeated at a high voltage.

In the positive electrode active material 904, a difference in the volume per unit cell between the O3 type crystal structure with a charge depth of 0 and the O3′ type crystal structure with a charge depth of 0.8 is less than or equal to 2.5%, more specifically, less than or equal to 2.2%.

In the unit cell of the O3′ type crystal structure, coordinates of cobalt and oxygen can be represented by Co (0, 0, 0.5) and O (0, 0, x) within the range of 0.20≤x≤0.25.

A slight amount of additive element such as magnesium existing between the CoO₂ layers, i.e., in lithium sites at random, has an effect of inhibiting a deviation in the CoO₂ layers. Thus, when magnesium exists between the CoO₂ layers, the O3′ type crystal structure is likely to be formed. Therefore, magnesium is preferably distributed over the whole particle of the positive electrode active material 904 of one embodiment of the present invention. In addition, to distribute magnesium over the whole particle, heat treatment is preferably performed in the formation process of the positive electrode active material 904 of one embodiment of the present invention.

However, cation mixing occurs when the heat treatment temperature is excessively high, so that an additive element such as magnesium is highly likely to enter the cobalt sites. Magnesium in the cobalt sites does not have the effect of maintaining the R-3m structure in high-voltage charging. Furthermore, when the heat treatment temperature is excessively high, adverse effects such as reduction of cobalt to have a valence of two and transpiration of lithium are concerned.

In view of the above, a halogen compound such as a fluorine compound is preferably added to lithium cobalt oxide before the heat treatment for distributing magnesium over the whole particle. The addition of the halogen compound decreases the melting point of the lithium cobalt oxide. The decrease in the melting point makes it easier to distribute magnesium over the whole particle at a temperature at which the cation mixing is less likely to occur. Furthermore, it is expected that the existence of the fluorine compound can improve corrosion resistance to hydrofluoric acid generated by decomposition of an electrolyte solution.

When the magnesium concentration is higher than a predetermined value, the effect of stabilizing a crystal structure becomes small in some cases. This is probably because magnesium enters the cobalt sites in addition to the lithium sites. The number of magnesium atoms contained in the positive electrode active material of one embodiment of the present invention is preferably 0.001 to 0.1 times, preferably larger than 0.01 times and less than 0.04 times, still further preferably approximately 0.02 times the number of transition metal atoms. The magnesium concentration described here may be a value obtained by element analysis on the whole particle of the positive electrode active material using ICP-MS or the like, or may be a value based on the ratio of the raw materials mixed in the formation process of the positive electrode active material, for example.

To lithium cobalt oxide, as a metal other than cobalt (an additive element), one or more metals selected from nickel, aluminum, manganese, titanium, vanadium, and chromium may be added, for example, and in particular, at least one of nickel and aluminum is preferably added. In some cases, manganese, titanium, vanadium, and chromium are likely to have a valence of four stably and thus contribute highly to a stable structure. The addition of the additive element may enable the positive electrode active material of one embodiment of the present invention to have a more stable crystal structure in high-voltage charging, for example. Here, in the positive electrode active material of one embodiment of the present invention, the additive element is preferably added at a concentration at which the crystallinity of the lithium cobalt oxide is not greatly changed. For example, the additive element is preferably added at an amount with which the aforementioned Jahn-Teller effect is not exhibited.

As shown in the legend in FIG. 10, aluminum and transition metals typified by nickel and manganese preferably exist in cobalt sites, but some of them may exist in lithium sites. Magnesium preferably exists in lithium sites. Part of oxygen may be substituted with fluorine.

As the magnesium concentration in the positive electrode active material of one embodiment of the present invention increases, the capacity of the positive electrode active material decreases in some cases. As an example, one possible reason is that the amount of lithium that contributes to charging and discharging decreases when magnesium enters the lithium sites. Furthermore, excess magnesium sometimes generates a magnesium compound that does not contribute to charging and discharging. When the positive electrode active material of one embodiment of the present invention contains nickel as the additive element in addition to magnesium, the capacity per weight and per volume can be increased in some cases. When the positive electrode active material of one embodiment of the present invention contains aluminum as the additive element in addition to magnesium, the capacity per weight and per volume can be increased in some cases. When the positive electrode active material of one embodiment of the present invention contains nickel and aluminum in addition to magnesium, the capacity per weight and per volume can be increased in some cases.

The concentrations of the elements, such as magnesium, contained in the positive electrode active material of one embodiment of the present invention are described below using the number of atoms.

The number of nickel atoms contained in the positive electrode active material of one embodiment of the present invention is preferably 10% or less, further preferably 7.5% or less, still further preferably 0.05% to 4%, particularly preferably 0.1% to 2% of the number of cobalt atoms. The nickel concentration described here may be a value obtained by element analysis on the whole particle of the positive electrode active material using ICP-MS or the like, or may be a value based on the ratio of the raw materials mixed in the formation process of the positive electrode active material, for example.

When a state being charged at a high voltage is held for a long time, the transition metal dissolves in an electrolyte solution from the positive electrode active material, and the crystal structure might be broken. However, when nickel is contained at the above-described proportion, dissolution of the transition metal from the positive electrode active material 904 can be inhibited in some cases.

The number of aluminum atoms in the positive electrode active material of one embodiment of the present invention is preferably 0.05% to 4%, further preferably 0.1% to 2% of the number of cobalt atoms. The aluminum concentration described here may be a value obtained by element analysis on the whole particle of the positive electrode active material using ICP-MS or the like, or may be a value based on the ratio of the raw materials mixed in the formation process of the positive electrode active material, for example.

It is preferable that the positive electrode active material of one embodiment of the present invention contain an additive element X, and phosphorus be used as the additive element X. The positive electrode active material of one embodiment of the present invention further preferably includes a compound containing phosphorus and oxygen.

When the positive electrode active material of one embodiment of the present invention includes a compound containing the additive element X, sometimes a short circuit is less likely to occur while the high-voltage charged state is maintained.

In the case where the positive electrode active material of one embodiment of the present invention contains phosphorus as the additive element X, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride might be generated by hydrolysis. In some cases, hydrogen fluoride is generated by the reaction of PVDF used as a component of the positive electrode and alkali. The decrease in hydrogen fluoride concentration in the electrolyte solution can inhibit corrosion of a current collector and/or separation of a coating film in some cases. Furthermore, the decrease in hydrogen fluoride concentration in the electrolyte solution can inhibit a reduction in adhesion properties due to gelling and/or insolubilization of PVDF in some cases.

When containing magnesium in addition to the additive element X, the positive electrode active material of one embodiment of the present invention is extremely stable in the high-voltage charged state. When the additive element X is phosphorus, the number of phosphorus atoms is preferably 1% or more and 20% or less, further preferably 2% or more and 10% or less, still further preferably 3% or more and 8% or less of the number of cobalt atoms. In addition, the number of magnesium atoms is preferably 0.1% or more and 10% or less, further preferably 0.5% or more and 5% or less, still further preferably 0.7% or more and 4% or less of the number of cobalt atoms. The phosphorus concentration and the magnesium concentration described here may each be a value obtained by element analysis on the whole particle of the positive electrode active material using ICP-MS or the like, or may be a value based on the ratio of the raw materials mixed in the formation process of the positive electrode active material, for example.

In the case where the positive electrode active material has a crack, phosphorus, more specifically, a compound containing phosphorus and oxygen, in the inner portion of the crack may inhibit crack development, for example.

As is obvious from oxygen atoms indicated by arrows in FIG. 10, the symmetry of the oxygen atoms slightly differs between the O3 type crystal structure and the O3′ type crystal structure. Specifically, the oxygen atoms in the O3 type crystal structure are arranged along the (−1 0 2) plane indicated by a dotted line, whereas the oxygen atoms in the O3′ type crystal structure are not strictly arranged along the (−1 0 2) plane. This is because, in the O3′ type crystal structure, an increase in tetravalent cobalt with a reduction in lithium expands the Jahn-Teller distortion and causes a distortion of the octahedral structure of CoO₆. In addition, an increase in repulsion between oxygen atoms in the CoO₂ layer with a reduction in lithium also affect.

Magnesium is preferably distributed in the whole particle of the positive electrode active material 904 of one embodiment of the present invention, and further preferably, the magnesium concentration in the surface portion is higher than the average in the whole particle. For example, the magnesium concentration in the surface portion which is measured by XPS or the like is preferably higher than the average magnesium concentration in whole particle measured by ICP-MS or the like.

In the case where the positive electrode active material 904 of one embodiment of the present invention contains an element other than cobalt, for example, one or more metals selected from nickel, aluminum, manganese, iron, and chromium, the concentration of the metal(s) in the surface portion of the particle is preferably higher than the average concentration of the metal(s) in the whole particle. For example, the concentration of the element other than cobalt in the surface portion measured by XPS or the like is preferably higher than the average concentration of the element in the whole particle measured by ICP-MS or the like.

The surface of the particle is a kind of crystal defects and lithium is extracted from the surface during charging; thus, the lithium concentration in the surface of the particle tends to be lower than that in the inner portion of the particle. Therefore, the surface of the particle tends to be unstable and its crystal structure is likely to break. The higher the magnesium concentration in the surface portion is, the more effectively the change in the crystal structure can be inhibited. In addition, when a magnesium concentration in the surface portion is high, it is expected that the corrosion resistance to hydrofluoric acid generated by the decomposition of the electrolyte solution is improved.

In addition, the concentration of halogen such as fluorine in the surface portion of the positive electrode active material 904 of one embodiment of the present invention is preferably higher than the average concentration in the whole particle. When halogen exists in the surface portion that is a region in contact with an electrolyte solution, the corrosion resistance to hydrofluoric acid can be effectively improved.

As described above, the surface portion of the positive electrode active material 904 of one embodiment of the present invention preferably has a composition different from that in the inner portion, i.e., the concentrations of additive elements such as magnesium and fluorine are preferably higher than those in the inner portion. In addition, the composition preferably has a crystal structure stable at normal temperature. Thus, the surface portion may have a crystal structure different from that of the inner portion. For example, at least part of the surface portion of the positive electrode active material 904 of one embodiment of the present invention may have a rock-salt crystal structure. Furthermore, in the case where the surface portion and the inner portion have different crystal structures, the orientations of crystals in the surface portion and the inner portion are preferably substantially aligned.

Anions of a layered rock-salt crystal and anions of a rock-salt crystal have a cubic close-packed structure (face-centered cubic lattice structure). Anions of an O3′ type crystal are also presumed to have a cubic close-packed structure. When these crystals are in contact with each other, there is a crystal plane at which orientations of cubic close-packed structures composed of anions are aligned. Note that a space group of the layered rock-salt crystal and the O3′ type crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned is sometimes referred to as a state where crystal orientations are substantially aligned.

Whether the crystal orientations in two regions are substantially aligned with each other can be judged from a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, and the like. X-ray diffraction (XRD), electron diffraction, neutron diffraction, and the like can also be used for judging. When the crystal orientations are substantially aligned with each other, a state where an angle between the orientations of lines in each of which cations and anions are alternately arranged is less than or equal to 5°, preferably less than or equal to 2.5° is observed from a TEM image and the like. Note that in a TEM image and the like, a light element typified by oxygen or fluorine cannot be clearly observed in some cases; in such a case, alignment of orientations can be judged by arrangement of metal elements.

Only with the structure where the surface portion contains only MgO or MgO and CoO(II) forms a solid solution, it is difficult to insert and extract lithium. Thus, the surface portion should contain at least cobalt, and further contain lithium in the discharged state to have a path through which lithium is inserted and extracted. In addition, the concentration of cobalt is preferably higher than that of magnesium.

The additive element X is preferably positioned on the surface portion of the particle in the positive electrode active material 904 of one embodiment of the present invention. For example, the positive electrode active material 904 of one embodiment of the present invention may be covered with a coating film containing the additive element X.

<<Grain boundary>> The additive element X contained in the positive electrode active material 904 of one embodiment of the present invention may randomly exist in the inner portion at a slight concentration, but part of the additive element is further preferably segregated at a grain boundary.

In other words, the concentration of the additive element X in the crystal grain boundary and its vicinity of the positive electrode active material 904 of one embodiment of the present invention is preferably higher than that in the other regions in the inner portion.

Like the particle surface, the crystal grain boundary is also a plane defect. Thus, the crystal grain boundary tends to be unstable and its crystal structure easily starts to change. Therefore, the higher the concentration of the additive element X in the crystal grain boundary and its vicinity is, the more effectively the change in the crystal structure can be inhibited.

In the case where the concentration of the addition element X is high in the grain boundary and its vicinity, even when a crack is generated along the grain boundary of the particle of the positive electrode active material 904 of one embodiment of the present invention, the concentration of the addition element X is increased in the vicinity of the surface generated by the crack. Thus, the positive electrode active material after the cracks are generated can also have increased corrosion resistance to hydrofluoric acid.

Note that in this specification and the like, the vicinity of the crystal grain boundary refers to a region of approximately 10 nm from the grain boundary.

<Particle Size>

A too large particle size of the positive electrode active material 904 causes problems such as difficulty in lithium diffusion and too much surface roughness of an active material layer in coating to a current collector. By contrast, too small a particle size causes problems such as difficulty in loading of the active material layer in coating to the current collector and overreaction with an electrolyte solution. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### <Analysis Method>

Whether or not a positive electrode active material has the O3′ type crystal structure when charged at high voltage can be determined by analyzing a high-voltage charged positive electrode using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example.

As described so far, the positive electrode active material 904 of one embodiment of the present invention has a feature of a small crystal structure change between the high-voltage charged state and the discharged state. A material where 50 wt % or more of the crystal structure largely changes between the high-voltage charged state and the discharged state is not preferable because the material cannot withstand the high-voltage charging and discharging. In addition, it should be noted that an objective crystal structure is not obtained in some cases only by addition of additive elements. For example, although the positive electrode active material that is lithium cobalt oxide containing magnesium and fluorine is a commonality, the positive electrode active material has 60 wt % or more of the O3′ type crystal structure in some cases, and has 50 wt % or more of the H1-3 type crystal structure in other cases, when charged at high voltage. Furthermore, at a predetermined voltage, the positive electrode active material has almost 100 wt % of the O3′ type crystal structure, and with an increase in the predetermined voltage, the H1-3 type crystal structure is generated in some cases. Thus, analysis of the crystal structure, including XRD, is needed to determine whether or not the positive electrode active material is the positive electrode active material 904 of one embodiment of the present invention.

Note that a positive electrode active material in the high-voltage charged state or the discharged state sometimes causes a change in the crystal structure when exposed to air. For example, the O3′ type crystal structure changes into the H1-3 type crystal structure in some cases. Thus, all samples are preferably handled in an inert atmosphere such as an argon atmosphere.

### Embodiment 4

In this embodiment, examples of electronic devices or moving vehicles each including the secondary battery of one embodiment of the present invention will be described.

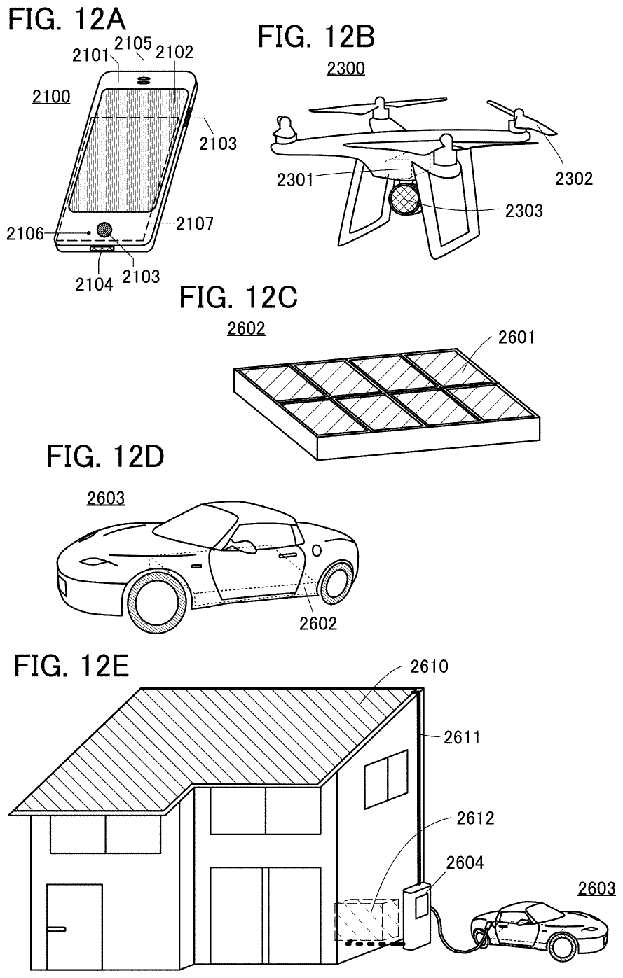

First, FIG. 12A to FIG. 12E illustrate examples of electronic devices each including the secondary battery described in part of Embodiment 3. Examples of the electronic device including the secondary battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

The secondary battery can also be used in moving vehicles, typically automobiles. Examples of the automobiles include next-generation clean energy vehicles such as hybrid vehicles (HEVs), electric vehicles (EVs), and plug-in hybrid vehicles (PHEVs), and the secondary battery can be used as one of the power sources provided for the automobiles. The moving vehicle is not limited to an automobile. Examples of moving vehicles include a train, a monorail train, a ship, a flying object (a helicopter, an unmanned aircraft (a drone), an airplane, and a rocket), an electric bicycle, and an electric motorcycle, and these moving vehicles can include the secondary battery of one embodiment of the present invention.

The secondary battery of this embodiment may be used in a ground-based charging apparatus provided for a house or a charging station provided in a commerce facility.

FIG. 12A illustrates an example of a mobile phone. A mobile phone 2100 includes a housing 2101 in which a display portion 2102 is incorporated, an operation button 2103, an external connection port 2104, a speaker 2105, a microphone 2106, and the like. Note that the mobile phone 2100 includes a secondary battery 2107.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, mutual communication with a headset capable of wireless communication allows hands-free calling.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 12B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery of one embodiment of the present invention is preferable as a secondary battery mounted on the unmanned aircraft 2300 because it has a high level of safety and thus can be used safely for a long time over a long period.

Furthermore, as illustrated in FIG. 12C, a secondary battery 2602 including a plurality of secondary batteries 2601 of one embodiment of the present invention may be mounted on a hybrid electric vehicle (HEV), an electric vehicle (EV), a plug-in hybrid electric vehicle (PHEV), or another electronic device.

FIG. 12D illustrates an example of a vehicle including the secondary battery 2602. A vehicle 2603 is an electric vehicle that runs using an electric motor as a power source. Alternatively, the vehicle 2603 is a hybrid electric vehicle that can run using a power source appropriately selected from an electric motor and an engine. The vehicle 2603 using the electric motor includes a plurality of ECUs (Electronic Control Units) and performs engine control by the ECUs. The ECU includes a microcomputer. The ECU is connected to a CAN (Controller Area Network) provided in the electric vehicle. The CAN is a type of a serial communication standard used as an in-vehicle LAN. With the use of the secondary battery of one embodiment of the present invention which can function as a power source of the ECU, a vehicle with a high level of safety and a high mileage can be achieved.

The secondary battery not only drives the electric motor (not illustrated) but also can supply electric power to a light-emitting device such as a headlight or a room light. Furthermore, the secondary battery can supply electric power to a display device and a semiconductor device included in the vehicle 2603, such as a speedometer, a tachometer, and a navigation system.

In the vehicle 2603, the secondary batteries included in the secondary battery 2602 can be charged by being supplied with electric power from external charging equipment by a plug-in system, a contactless power feeding system, or the like.

FIG. 12E illustrates a state in which the vehicle 2603 is supplied with electric power from ground-based charging equipment 2604 through a cable. In charging, a given method such as CHAdeMO (registered trademark) or Combined Charging System may be employed as a charging method, the standard of a connector, or the like as appropriate. For example, with a plug-in technique, the secondary battery 2602 mounted on the vehicle 2603 can be charged by being supplied with electric power from the outside. Charging can be performed by converting AC power into DC power through a converter such as an ACDC converter. The charging equipment 2604 may be provided for a house as illustrated in FIG. 12E, or may be a charging station provided in a commercial facility.

Although not illustrated, the vehicle can include a power receiving device so as to be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, this contactless power feeding system may be utilized to transmit and receive electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

The house illustrated in FIG. 12E includes a power storage system 2612 including the secondary battery of one embodiment of the present invention and a solar panel 2610. The power storage system 2612 is electrically connected to the solar panel 2610 through a wiring 2611 or the like. The power storage system 2612 may be electrically connected to the ground-based charging equipment 2604. The power storage system 2612 can be charged with electric power generated by the solar panel 2610. The secondary battery 2602 included in the vehicle 2603 can be charged with the electric power stored in the power storage system 2612 through the charging equipment 2604.

The electric power stored in the power storage system 2612 can also be supplied to other electronic devices in the house. Thus, with the use of the power storage system 2612 of one embodiment of the present invention as an uninterruptible power source, electronic devices can be used even when electric power cannot be supplied from a commercial power source due to power failure or the like.

This embodiment can be implemented in appropriate combination with the other embodiments.

### Embodiment 5

In this embodiment, a relationship among a positive electrode active material particle, an electrolyte solution, an additive agent, and the like will be described below.

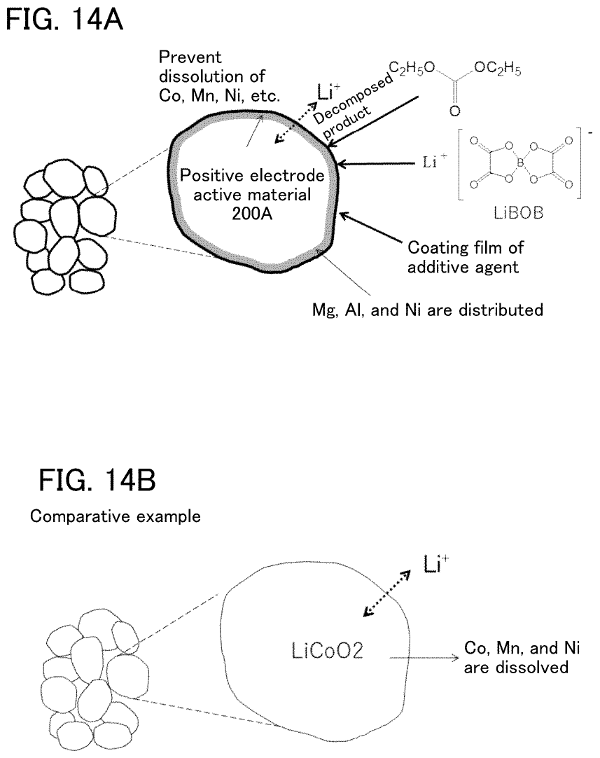

FIG. 14A is a model diagram illustrating a plurality of positive electrode active materials in the secondary battery in Embodiment 1 or Embodiment 2, and a state of an electrolyte solution, an additive agent, and the like that are placed around the positive electrode active materials. FIG. 14A shows a model diagram illustrating the plurality of particles on the left and one enlarged particle on the right.

As shown in FIG. 14A, a Li⁺ ion moves into the particle of the positive electrode active material 200A and moves into the electrolyte solution when charging and discharging is performed.

In the illustrated state, Mg, Al, and Ni are distributed in the surface portion of the particle of the positive electrode active material 200A, and a coating film of the additive agent is formed on the surface at least partly. The coating film of the additive agent is formed by attachment of boron (B) in LiBOB on part of the particle of the positive electrode active material 200A. The region where Mg, Al, and Ni are distributed also contains fluorine, which inhibits dissolution of a transition metal contained in the particle, typically cobalt (or manganese, nickel, or the like), into the electrolyte solution. Moreover, the coating film also inhibits dissolution of the transition metal into the electrolyte solution. Furthermore, the coating film also inhibits a side reaction with the electrolyte solution. The synergy of existence of the region where Mg, Al, and Ni are distributed and the coating film significantly improves the reliability.

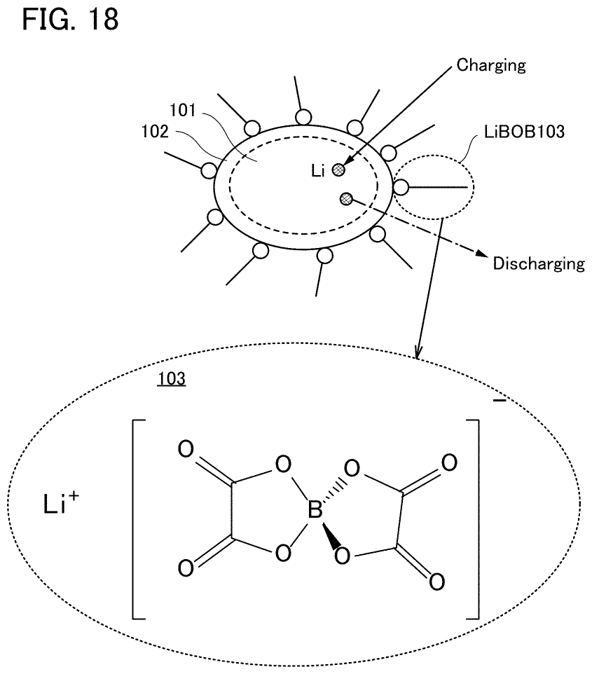

As a comparative example, FIG. 14B is a model diagram illustrating the state where charging and discharging is performed on a plurality of LiCoO₂ particles in a conventional secondary battery. FIG. 14B shows a model diagram illustrating the plurality of particles on the left and one enlarged particle on the right. FIG. 18 is an example of a model showing a relationship between a positive electrode active material particle 101 and an additive agent 103. As shown in FIG. 18, adding LiBOB to an electrolyte solution generates a portion where LiBOB is in contact with a surface portion 102 of the positive electrode active material particle 101 and a portion where LiBOB is not in contact with the surface portion 102; at the time of charging and discharging, Li moves in and out of the positive electrode active material particle 101 through a space between the regions where LiBOB is in contact with the surface portion 102. Adding an appropriate amount of LiBOB to the electrolyte solution can inhibit dissolution of nickel, manganese, or the like contained in the positive electrode active material particle 101. The amount of LiBOB added to the electrolyte solution is preferably regarded as being optimum when LiBOB is in contact with the surface portion 102 of the positive electrode active material particle 101.

As shown in FIG. 14B, a Li⁺ ion moves into the LiCoO₂ particle and moves into the electrolyte solution when charging and discharging are performed. It is also shown that a transition metal contained in the LiCoO₂ particle, typically cobalt (or manganese, nickel, or the like) is dissolved into the electrolyte solution by charging and discharging. There is a problem in that the dissolved cobalt is attached to the negative electrode of the secondary battery and accelerate deterioration.

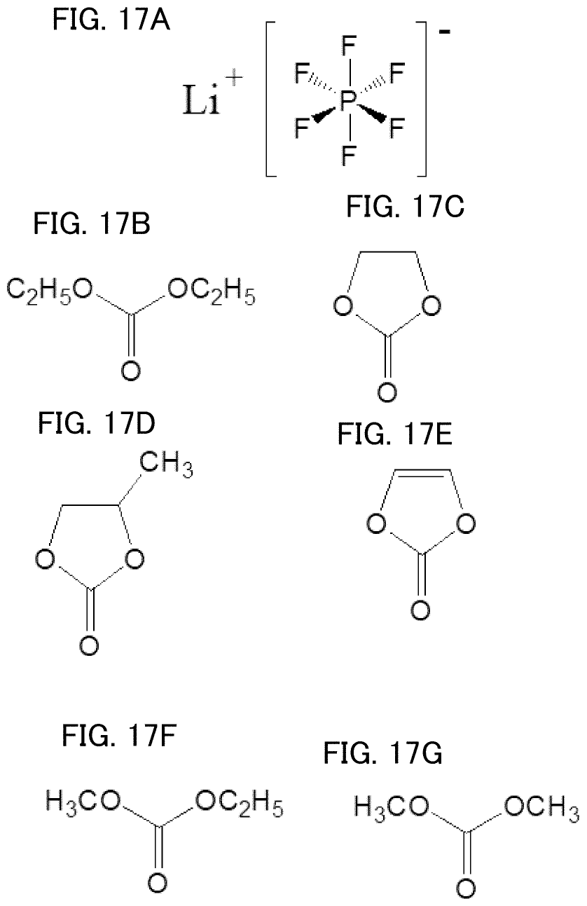

In the secondary battery of Embodiment 1 or Embodiment 2, LiPF₆ shown in FIG. 17A is used as the lithium salt in the electrolyte solution. In addition, diethyl carbonate (DEC) shown in FIG. 17B and ethylene carbonate (EC) shown in FIG. 17C are used in the electrolyte solution.

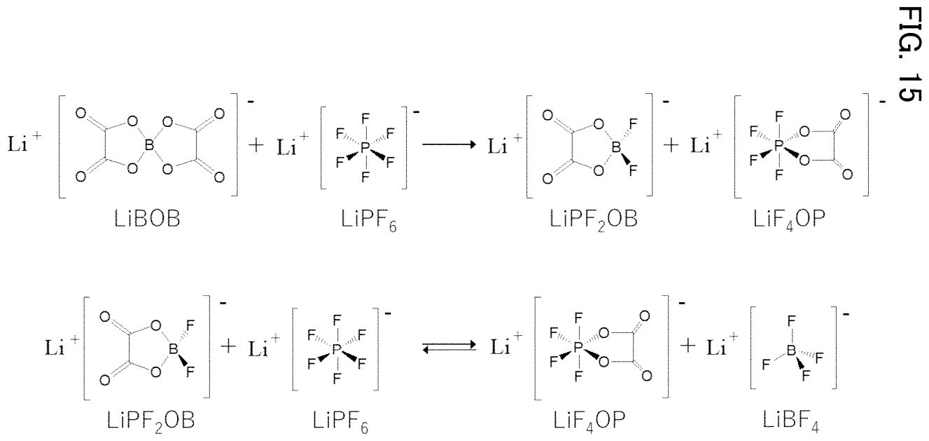

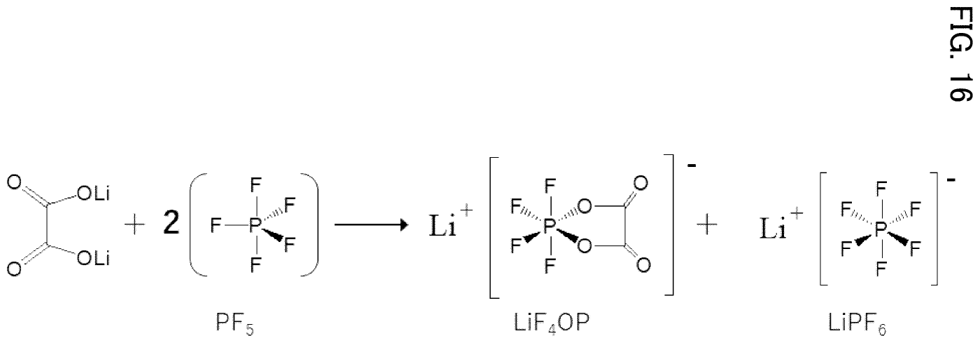

Examples of chemical reaction that occurs in the secondary battery are shown in FIG. 15 and FIG. 16.

As another solvent of the electrolyte solution, propylene carbonate (PC) shown in FIG. 17D, ethyl methyl carbonate (EMC) shown in FIG. 17F, and dimethyl carbonate (DMC) shown in FIG. 17G can be used. As another solvent of the electrolyte solution, one of butylene carbonate, chloroethylene carbonate, γ-butyrolactone, γ-valerolactone, methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio. In this embodiment, not only LiBOB but also another additive agent (vinylene carbonate (VC), propanesultone (PS), tert-butylbenzene (TBB), fluoroethylene carbonate (FEC), a dinitrile compound such as succinonitrile or adiponitrile, or the like) may be added as the additive agent. Note that vinylene carbonate (VC) shown in FIG. 17E is an additive agent.

This embodiment can be implemented in appropriate combination with the other embodiments.

### REFERENCE NUMERALS

200A: positive electrode active material, 200B: positive electrode active material, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte solution, 509: exterior body, 510: positive electrode lead electrode, 511: negative electrode lead electrode, 600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 612: safety valve mechanism, 613: conductive plate, 614: conductive plate, 615: module, 616: wiring, 617: temperature control device, 902: mixture, 903: mixture, 2100: mobile phone, 2101: housing, 2102: display portion, 2103: operation button, 2104: external connection port, 2105: speaker, 2106: microphone, 2107: secondary battery, 2300: unmanned aircraft, 2301: secondary battery, 2302: rotor, 2303: camera, 2601: secondary battery, 2602: secondary battery, 2603: vehicle, 2604: charging equipment, 2610: solar panel, 2611: wiring, 2612: power storage system

1. A secondary battery comprising:
a positive electrode active material comprising lithium, a transition metal, magnesium, oxygen, and fluorine; and
an electrolyte solution comprising lithium bis(oxalato)borate.

2. The secondary battery according to claim 1, wherein the transition metal is at least one of cobalt, nickel, and manganese.

3. The secondary battery according to claim 1, wherein the positive electrode active material comprises aluminum.

4. The secondary battery according to claim 1, wherein the electrolyte solution comprises a lithium salt, and diethyl carbonate and ethylene carbonate each dissolving the lithium salt.

5. The secondary battery according to claim 4, wherein the lithium salt is lithium hexafluorophosphate.

6. The secondary battery according to claim 1, wherein a negative electrode active material of the secondary battery is graphene.

7. The secondary battery according to claim 1, wherein a proportion of the lithium bis(oxalato)borate in the electrolyte solution is higher than 0.1 wt % and lower than 3 wt %.

8. A secondary battery comprising:
a positive electrode;
a negative electrode; and
an electrolyte solution comprising lithium bis(oxalato)borate,
wherein the positive electrode comprises a positive electrode active material and a coating film in contact with a surface of the positive electrode active material,
wherein the positive electrode active material comprises lithium, cobalt, oxygen, magnesium, aluminum, and fluorine,
wherein the coating film comprises boron.

9. The secondary battery according to claim 8, wherein the electrolyte solution comprises a lithium salt, and diethyl carbonate and ethylene carbonate each dissolving the lithium salt.

10. The secondary battery according to claim 9, wherein the lithium salt is lithium hexafluorophosphate.

11. The secondary battery according to claim 8, wherein a negative electrode active material of the secondary battery is graphene.
